(19) United States
(12) Patent Application Publication
(10) Pub. No.: US 2024/0112267 A1
(43) Pub. Date: Apr. 4, 2024

(54) DIGITAL INVENTORY VIA NFTS OF INSURED ITEMS

(71) Applicant: STATE FARM MUTUAL AUTOMOBILE INSURANCE COMPANY, Bloomington, IL (US)

(72) Inventors: Brian N. Harvey, Bloomington, IL (US); Joseph Robert Brannan, Bloomington, IL (US); Joseph P. Harr, Bloomington, IL (US); Edward W. Breitweiser, Bloomington, IL (US)

(21) Appl. No.: 18/124,485

(22) Filed: Mar. 21, 2023

Related U.S. Application Data
(60) Provisional application No. 63/424,019, filed on Nov. 9, 2022.
(60) Provisional application No. 63/411,399, filed on Sep. 29, 2022.

(51) Int. Cl. G06Q 40/08; G06Q 10/087; G06Q 20/36

(52) U.S. Cl. CPC G06Q 40/08; G06Q 10/087; G06Q 20/3672

(57) ABSTRACT

The following relates generally to updating an inventory of insured items. In some embodiments, one or more processors: identify a digital wallet of non-fungible tokens (NFTs) configured to store NFTs that correspond to insured items associated with an individual; detect a request to add a NFT corresponding to an insured item to the digital wallet; update the digital wallet to include the NFT; and display a virtual representation of the insured items of the NFTs of the digital wallet.

### CROSS REFERENCE TO RELATED APPLICATIONS

This application claims the benefit of (1) U.S. Provisional Patent Application No. 63/411,399, entitled “Using Metaverse to Replace Physical Items; Insuring NFTs; and Digital Inventory of Insured Items,” filed Sep. 29, 2022, and (2) U.S. Provisional Patent Application No. 63/424,019, entitled “Using Metaverse To Replace Or Repair Physical Items; Insuring NFTs; And Digital Inventory Of Insured Items,” filed Nov. 9, 2022. U.S. Provisional Patent Application No. 63/411,399, and U.S. Provisional Patent Application No. 63/424,019 are hereby expressly incorporated by reference herein in their entirety.

### FIELD

The present disclosure generally relates to (i) assisting with replacement of a physical item; (ii) insurance for non-fungible tokens (NFTs); (iii) updating an inventory of insured items; and/or (iv) assisting with repair of a physical item.

### BACKGROUND

Sometimes, when placing an insurance claim, an insurance customer will seek to replace an item that is lost. For example, when placing an insurance claim for a car that was destroyed during an accident, the insurance customer may also want to determine a suitable replacement car. However, it is sometimes challenging to determine suitable replacement items.

In addition, NFTs (e.g., on a distributed ledger) may represent ownership of a digital or physical asset. However, in certain situations, the NFT may become compromised (e.g., the distributed ledger is hacked, etc.).

In addition, many insurance policies (e.g., homeowners, and renters insurance policies) cover a wide range of items in the event of a loss. However, many insurance policy owners do not keep inventory lists of items that are covered in the event of a loss, or have inventory lists that are outdated.

In addition, when placing an insurance claim, an insurance customer may seek to repair or replace an item. For example, a customer may seek to repair or replace a roof or floor of a house as part of a homeowners insurance claim. However, it is sometimes challenging to determine repair or replacement options, and/or select from repair or replacement options.

The systems and methods disclosed herein provide solutions to these problems and may provide solutions to other drawbacks of conventional techniques.

### SUMMARY

The present embodiments relate to, inter alia, assisting with replacement of a physical item. For example, as part of placing an insurance claim, an insurance customer may indicate an item that was lost (e.g., a piece of furniture, an electronics item, a vehicle, etc.). To aid the insurance customer in determining a suitable replacement, an insurance company may determine a set of replacement items to present to the insurance customer. For improved presentation, the set of replacement items may be presented to the insurance customer in a virtual environment. In this regard, it should be understood that the insurance customer may also be the user of a virtual environment.

In one aspect, a computer-implemented method for assisting with replacement of a physical item may be provided. The method may be implemented via one or more local or remote processors, sensors, transceivers, servers, memory units, augmented reality glasses or headsets, extended or virtual reality headsets, smart glasses or watches, wearables, and/or other electronic or electrical components. In one aspect, the method may include: (1) receiving, via one or more processors, an indication of an insurance claim, wherein the indication of the insurance claim: (i) includes an indication of a physical item to be replaced, and (ii) arises from a virtual environment; (2) determining, via the one or more processors, a set of potential replacement items for the physical item to be replaced; (3) retrieving, via the one or more processors, virtual data of the set of potential replacement items; and/or (4) presenting, via the one or more processors, in the virtual environment, and based upon the retrieved virtual data of the set of potential replacement items, the set of potential replacement items to a user. The method may include additional, fewer, or alternate actions, including those discussed elsewhere herein.

In another aspect, a computer-implemented method for assisting with replacement of a physical item may be provided. The method may be implemented via one or more local or remote processors, sensors, transceivers, servers, memory units, augmented reality glasses or headsets, extended or virtual reality headsets, smart glasses or watches, wearables, and/or other electronic or electrical components. In one aspect, the method may include: (1) receiving, via one or more processors, an indication of an insurance claim, wherein the indication of the insurance claim: (i) includes an indication of a physical item to be replaced, and/or (ii) arises from a virtual environment; (2) determining, via the one or more processors, a set of potential replacement items for the physical item to be replaced; (3) building, via the one or more processors, virtual item models of items of the set of potential replacement items in a format operable to import virtual versions of the items of the set of potential replacement items into the virtual environment; and/or (4) sending, via the one or more processors, to a virtual environment server: (i) an instruction to present the set of potential replacement items in the virtual environment, and/or (ii) the virtual item models. The method may include additional, fewer, or alternate actions, including those discussed else-where herein.

In another aspect, a computer system configured to assist with replacement of a physical item may be provided. The computer system may include one or more local or remote processors, sensors, transceivers, servers, memory units, augmented reality glasses or headsets, extended or virtual reality headsets, smart glasses or watches, wearables, and/or other electronic or electrical components. In one aspect, the computer system may include one or more processors configured to: (1) receive an indication of an insurance claim, wherein the indication of the insurance claim: (i) includes an indication of a physical item to be replaced, and/or (ii) arises from a virtual environment; (2) determine a set of potential replacement items for the physical item to be replaced; (3) retrieve virtual data of the set of potential replacement items; and/or (4) present, in the virtual environment, and based upon the retrieved virtual data of the set of potential replacement items, the set of potential replacement items to a user. The computer system may include additional, less, or alternate functionality, including that discussed elsewhere herein.

The present embodiments also relate to, inter alia, insurance for NFTs. For example, an NFT is a record on a distributed ledger which may be associated with (e.g., represent ownership of on the distributed ledger, etc.) of a digital asset (e.g., an image, a video, an audio recording, etc.), and/or a physical asset (e.g., real estate, a vehicle, etc.). However, in certain situations, the NFT may become compromised (e.g., the distributed ledger is hacked, etc.). To remedy and/or mitigate this, embodiments disclosed herein provide techniques for insurance of NFTs.

In one aspect, a computer-implemented method for insurance of a non-fungible token (NFT) may be provided. The method may be implemented via one or more local or remote processors, sensors, transceivers, servers, memory units, augmented reality glasses or headsets, extended or virtual reality headsets, smart glasses or watches, wearables, and/or other electronic or electrical components. For instance, the method may include: (1) receiving, via one or more processors and from a computing device of a customer, a request to purchase insurance for the NFT; (2) analyzing, via the one or more processors, a distributed ledger associated with the NFT to determine at least one insurability metric, wherein the at least one insurability metric includes: (i) a reliability rating of the distributed ledger, (ii) a uniqueness rating of the digital asset, (iii) a historical price paid for the NFT, (iv) prices paid for other NFTs on the distributed ledger, (v) a length of time the NFT has existed, and/or (vi) a minter of the NFT; (3) determining, via the one or more processors, an insurance premium for the insurance of the NFT based upon the determined at least one insurability metric; and/or (4) sending, via the one or more processors, an insurance quote including the determined insurance premium to the computing device of the customer. The method may include additional, fewer, or alternate actions, including those discussed elsewhere herein.

In another aspect, a computer system configured to provide insurance of a non-fungible token (NFT) of one or more virtual items in a virtual environment may be provided. The computer system may include one or more local or remote processors, sensors, transceivers, servers, memory units, augmented reality glasses or headsets, extended or virtual reality headsets, smart glasses or watches, wearables, and/or other electronic or electrical components. For instance, the computer system may include one or more processors configured to: (1) receive, from a computing device of a customer, a request to purchase insurance for the NFT; (2) analyze a distributed ledger associated with the NFT to determine at least one insurability metric, wherein the at least one insurability metric includes: (i) a reliability rating of the distributed ledger, (ii) a uniqueness rating of the digital asset, (iii) a historical price paid for the NFT, (iv) prices paid for other NFTs on the distributed ledger, (v) a length of time the NFT has existed, and/or (vi) a minter of the NFT; (3) determine an insurance premium for the insurance of the NFT based upon the determined at least one insurability metric; and/or (4) send an insurance quote including the determined insurance premium to the computing device of the customer. The computer system may include additional, less, or alternate functionality, including that discussed elsewhere herein.

In yet another aspect, a computer device configured to provide insurance of a non-fungible token (NFT) may be provided. The computer device may include: one or more processors; and/or one or more memories coupled to the one or more processors. The one or more memories including computer executable instructions stored therein that, when executed by the one or more processors, cause the one or more processors to: (1) receive, from a computing device of a customer, a request to purchase insurance for the NFT; (2) analyze a distributed ledger of the NFT to determine at least one of: (i) a reliability rating of the distributed ledger of the NFT, (ii) a uniqueness rating of the digital asset, (iii) a previous price paid for the NFT, (iv) prices paid for other NFTs on the distributed ledger of the NFT, and/or (v) a length of time the NFT has existed; (3) determine an insurance premium for the insurance of the NFT based upon the determined at least one of: (i) the reliability rating of a distributed ledger of the NFT, (ii) the uniqueness rating of the digital asset, (iii) the previous price paid for the NFT, (iv) prices paid for other NFTs on the distributed ledger of the NFT, and/or (v) the length of time the NFT has existed; and/or (4) send an insurance quote including the determined insurance premium to the computing device of the customer. The computer device may include additional, less, or alternate functionality, including that discussed elsewhere herein.

The present embodiments also relate to, inter alia, updating an inventory of insured items. Generally, many insurance policies (e.g., homeowners, and renters insurance policies) cover a wide range of items in the event of a loss. For example, if a home is lost, a homeowners insurance policy may cover personal articles, such as electronics, furniture, etc. that were lost along with the home. As such, it is useful for an insurance customer to keep an updated inventory list of insured items. To this end, the techniques described herein may provide such an inventory via a digital wallet of non-fungible tokens (NFTs) configured to store NFTs that correspond to insured items associated with the insurance customer.

In one aspect, a computer-implemented method for updating an inventory of insured items may be provided. The method may be implemented via one or more local or remote processors, sensors, transceivers, servers, memory units, augmented reality glasses or headsets, extended or virtual reality headsets, smart glasses or watches, wearables, and/or other electronic or electrical components. For instance, the method may include: (1) identifying, via one or more processors, a digital wallet of non-fungible tokens (NFTs) configured to store NFTs that correspond to insured items associated with an individual; (2) detecting, via the one or more processors, a request to add a NFT corresponding to an insured item to the digital wallet; and/or (3) updating, via the one or more processors, the digital wallet to include the NFT, wherein the update to the digital wallet triggers a smart contract associated with the digital wallet to update an insurance policy based upon the updated digital wallet. The method may include additional, fewer, or alternate actions, including those discussed elsewhere herein.

In another aspect, a computer system configured to update an inventory of insured items may be provided. The computer system may include one or more local or remote processors, sensors, transceivers, servers, memory units, augmented reality glasses or headsets, extended or virtual reality headsets, smart glasses or watches, wearables, and/or other electronic or electrical components. For instance, the computer system may include one or more processors configured to: (1) identify a digital wallet of non-fungible tokens (NFTs) configured to store NFTs that correspond to insured items associated with an individual; (2) detect a request to add a NFT corresponding to an insured item to the digital wallet; and/or (3) update the digital wallet to include the NFT, wherein the update to the digital wallet triggers a smart contract associated with the digital wallet to update an insurance policy based upon the updated digital wallet. The computer system may include additional, less, or alternate functionality, including that discussed elsewhere herein.

In yet another aspect, a computer device configured to update an inventory of insured items may be provided. The computer device may include: one or more processors; and/or one or more memories coupled to the one or more processors. The one or more memories including computer executable instructions stored therein that, when executed by the one or more processors, may cause the one or more processors to: (1) identify a digital wallet of non-fungible tokens (NFTs) configured to store NFTs that correspond to insured items associated with an individual; (2) detect a request to add a NFT corresponding to an insured item to the digital wallet; and/or (3) update the digital wallet to include the NFT, wherein the update to the digital wallet triggers a smart contract associated with the digital wallet to update an insurance policy based upon the updated digital wallet. The computer device may include additional, less, or alternate functionality, including that discussed elsewhere herein.

The present embodiments relate to, inter alia, assisting with repair of a damaged physical item. For example, as part of placing an insurance claim, an insurance customer may indicate an item that was damaged (e.g., a house, a vehicle, a personal article, such as a piece of furniture, an electronics item, etc.). To aid the insurance customer in determining a suitable repair or preplacement, an insurance company may determine a set of acceptable repair and/or replacement options to present to the insurance customer. For improved presentation, the set of repair and/or replacement options may be presented to the insurance customer in a virtual environment. In this regard, it should be understood that the insurance customer may also be the user of a virtual environment.

In one aspect, a computer-implemented method for assisting with repair (and/or replacement) of a physical item may be provided. The method may be implemented via one or more local or remote processors, sensors, transceivers, servers, memory units, augmented reality glasses or headsets, extended or virtual reality headsets, smart glasses or watches, wearables, and/or other electronic or electrical components. In one aspect, the method may include: (1) receiving, via one or more processors, an indication of an insurance claim, wherein the indication of the insurance claim: (i) includes an indication of a physical item to be repaired (and/or replaced), and (ii) arises from a virtual environment; (2) determining, via the one or more processors, a set of potential repair (and/or replacement) options for the physical item to be repaired; (3) building, via the one or more processors, virtual model of the physical item to be repaired; and/or (4) presenting, via the one or more processors, in the virtual environment: (i) a representation of the physical item to be repaired (and/or replaced) based upon the virtual model of the physical item to be repaired (and/or replaced), (ii) a virtual representation of a repaired (and/or replacement) version of the physical item to be repaired (and/or replaced) based upon the virtual model of the physical item to be repaired (and/or replaced), and/or (iii) the set of potential repair (and/or replacement) options to a user. The method may include additional, fewer, or alternate actions, including those discussed elsewhere herein.

In another aspect, a computer system configured to assist with repair (and/or replacement) of a physical item may be provided. The computer system may include one or more local or remote processors, sensors, transceivers, servers, memory units, augmented reality glasses or headsets, extended or virtual reality headsets, smart glasses or watches, wearables, and/or other electronic or electrical components. In one aspect, the computer system may include one or more processors configured to: (1) receive an indication of an insurance claim, wherein the indication of the insurance claim: (i) includes an indication of a physical item to be repaired (and/or replaced), and (ii) arises from a virtual environment; (2) determine a set of potential repair (and/or replacement) options for the physical item to be repaired; (3) build virtual model of the physical item to be repaired (and/or replaced); and/or (4) present, in the virtual environment: (i) a representation of the physical item to be repaired (and/or replaced) based upon the virtual model of the physical item to be repaired (and/or replaced), (ii) a virtual representation of a repaired (and/or replaced) version of the physical item to be repaired (and/or replaced) based upon the virtual model of the physical item to be repaired (and/or replaced), and (iii) the set of potential repair options to a user. The computer system may include additional, less, or alternate functionality, including that discussed elsewhere herein.

In yet another aspect, a computer device configured to assist with repair of a physical item may be provided. The computer device may include: one or more processors; and/or one or more memories coupled to the one or more processors. The one or more memories including computer executable instructions stored therein that, when executed by the one or more processors, cause the one or more processors to: (1) receive an indication of an insurance claim, wherein the indication of the insurance claim: (i) includes an indication of a physical item to be repaired (and/or replaced), and (ii) arises from a virtual environment; (2) determine a set of potential repair (and/or replacement) options for the physical item to be repaired; (3) build virtual model of the physical item to be repaired (and/or replaced); and/or (4) present, in the virtual environment: (i) a representation of the physical item to be repaired (and/or replaced) based upon the virtual model of the physical item to be repaired (and/or replaced), (ii) a virtual representation of a repaired (and/or replacement) version of the physical item to be repaired (and/or replaced) based upon the virtual model of the physical item to be repaired (and/or replaced), and (iii) the set of potential repair (and/or replacement) options to a user. The computer device may include additional, less, or alternate functionality, including that discussed elsewhere herein.

### BRIEF DESCRIPTION OF THE DRAWINGS

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

The figures described below depict various aspects of the applications, methods, and systems disclosed herein. It should be understood that each figure depicts an embodiment of a particular aspect of the disclosed applications, systems and methods, and that each of the figures is intended to accord with a possible embodiment thereof. Furthermore, wherever possible, the following description refers to the reference numerals included in the following figures, in which features depicted in multiple figures are designated with consistent reference numerals.

FIG. 1 depicts an exemplary computer system for assisting with replacement or repair of a physical item, according to one embodiment.

FIG. 2 shows an exemplary environment including a set of potential replacement items being presented to character.

FIG. 3 depicts an exemplary signal diagram for assisting with replacement of a physical item, according to one embodiment.

FIG. 4 depicts an exemplary signal diagram for assisting with replacement of a physical item, including building virtual item models, according to one embodiment.

FIG. 5 shows an exemplary table of historical information of replaced items, and replacement items.

FIG. 6 shows an exemplary method of assisting with replacement of a physical item.

FIG. 7 shows an exemplary method of assisting with replacement of a physical item, including building virtual item models.

FIG. 8 shows an exemplary computer system for insurance of an NFT.

FIG. 9A illustrates an exemplary block diagram of an example machine learning modeling method for training and evaluating a machine algorithm, in accordance with various embodiments.

FIG. 9B illustrates an exemplary table of historical NFT information.

FIG. 10 illustrates exemplary network nodes and an exemplary distributed ledger.

FIG. 11 illustrates exemplary network nodes, and an exemplary transaction flow on a distributed ledger network.

FIG. 12 illustrates exemplary components of a network node on a distributed ledger network.

FIG. 13 shows an exemplary computer-implemented method of providing insurance for NFTs.

FIG. 14 shows an exemplary computer system for updating an inventory.

FIG. 15 shows an exemplary computer-implemented method of updating an inventory of insured items.

FIG. 16 shows an exemplary display of an exemplary wallet of NFTs in list form.

FIG. 17 shows an exemplary display of an exemplary wallet of NFTs via a virtual environment.

FIG. 18 shows an exemplary computer-implemented method of updating an inventory of insured items, including a phase of gathering NFTs that correspond to items associated with an individual.

FIG. 19 shows an exemplary virtual environment including a virtual car with a scratched door, and a virtual car with a repaired door being presented to a virtual character.

FIG. 20 depicts an exemplary signal diagram for assisting with repair of a physical item, according to one embodiment.

FIG. 21 shows an exemplary method of assisting with repair (and/or replacement) of a physical item, according to one embodiment.

### DETAILED DESCRIPTION

The systems and methods disclosed herein relate to, inter alia, (i) assisting with replacement of a physical item; (ii) insurance for non-fungible tokens (NFTs); and/or (iii) updating an inventory of insured items.

As used herein, the term virtual environment should be understood to refer to a virtual world, such as a metaverse, a virtual game world, an augmented-reality based virtual world, etc. As is understood in the art, in some examples, the virtual environment may be accessed by any computing device, such as a computer, a tablet, a smartphone or mobile device, a virtual reality (VR) headset, an augmented reality (AR) headset or glasses, smart glasses, smart watches, wearables, etc.

As used herein, the term size (e.g., of a physical item) should be understood to mean a length, width, and/or depth (e.g., of the physical item).

Exemplary System for Assisting with Replacement and/or Repair of a Physical Item

Often, when an item is damaged, an owner of the item must make a decision of whether to replace or repair the item. Many factors may go into this decision, such as cost to repair the item, cost to replace the item, replacement options available, repair options available, and so on. To this end, some embodiments leverage aspects of the virtual environment to aid a user in selecting a replacement option, and/or selecting a repair option.

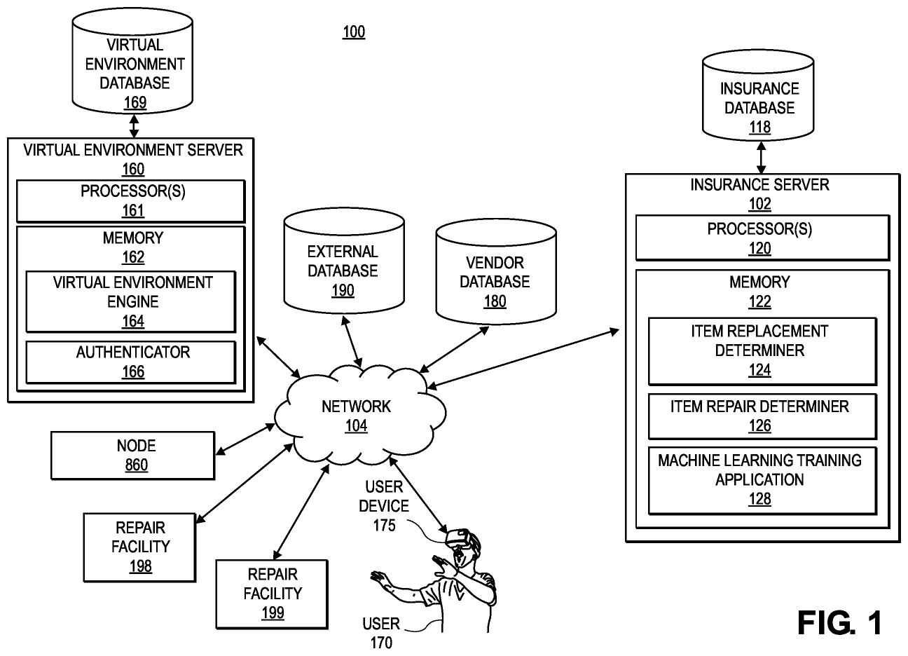

FIG. 1 shows an exemplary computer system 100 for replacement and/or repair of physical items in which the exemplary computer-implemented methods described herein may be implemented. The high-level architecture includes both hardware and software applications, as well as various data communications channels for communicating data between the various hardware and software components.

Broadly speaking, a virtual environment, such as a metaverse, may be provided by the virtual environment server 160. The virtual environment may allow user-controlled characters (e.g., as represented by avatars in the virtual environment) to traverse the virtual world, interact with each other, gain experience, make purchases for real or virtual items, etc. As referred to herein, purchases refer to purchases made in traditional currency (e.g., U.S. dollars, Euros, etc.), cryptocurrency (e.g., Bitcoin, etc.), virtual currency (e.g., a currency used solely in the virtual world), and/or in exchange for other real or virtual items.

The virtual environment server 160 may include one or more processors 161 such as one or more microprocessors, controllers, and/or any other suitable type of processor. The virtual environment server 160 may further include a memory 162 (e.g., volatile memory, non-volatile memory) accessible by the one or more processors 161, (e.g., via a memory controller). The one or more processors 161 may interact with the memory 162 to obtain and execute, for example, computer-readable instructions stored in the memory 162. Additionally or alternatively, computer-readable instructions may be stored on one or more removable media (e.g., a compact disc, a digital versatile disc, removable flash memory, etc.) that may be coupled to the virtual environment server 160 to provide access to the computer-readable instructions stored thereon. In particular, the computer-readable instructions stored on the memory 162 may include instructions for executing various applications, such as virtual environment engine 164, and/or an authenticator 166.

In operation, the virtual environment engine 164 may provide the virtual environment. For example, as described elsewhere herein, the virtual environment engine 164 may provide the virtual environment to users such that characters may travel through the virtual environment, interact with each other, gain experience, make purchases, etc.

For instance, a user 170 may wish to participate in the virtual environment. To do so, the user 170 may use a user device 175 (e.g., a virtual reality (VR) headset, a computer, a tablet, a smartphone, an augmented reality (AR) headset, a server, etc.) to access the virtual environment. In this way, the user 170 may create a character to interact with the virtual environment.

The virtual environment engine 164 may store information of the character in the memory 162 and/or the virtual environment database 169. Furthermore, the memory 162 and/or the virtual environment database 169 may store any information related to the virtual environment. For example, the memory 162 and/or the virtual environment database 169, may store information of: characters, buildings, objects (e.g., vehicles, items of the characters, such as tools, weapons, etc.), businesses (e.g., insurance business, such as an insurance business that owns insurance server 102), etc.

To access the virtual environment, in some examples, the user 170 must be authenticated. To this end, the authenticator 166 may authenticate the user 170. For example, the user 170 may be authenticated based upon authentication credentials, such as biometric data received from the user device 175 (e.g., a VR headset automatically gathers biometric data and sends it as part of the authentication process).

Additionally or alternatively to authenticating the user 170, the authenticator 166 may authenticate the insurance server 102. Once authenticated, in some embodiments, the insurance server 102 may be permitted by the virtual environment server 160 to provide insurance services to users of the virtual environment (e.g., user 170). For example, as will be described elsewhere herein, the insurance server 102 may provide assistance for replacement and/or repair of physical items via the virtual environment.

The insurance server 102 may include one or more processors 120 such as one or more microprocessors, controllers, and/or any other suitable type of processor. The insurance server 102 may further include a memory 122 (e.g., volatile memory, non-volatile memory) accessible by the one or more processors 120, (e.g., via a memory controller). The one or more processors 120 may interact with the memory 122 to obtain and execute, for example, computer-readable instructions stored in the memory 122. Additionally or alternatively, computer-readable instructions may be stored on one or more removable media (e.g., a compact disc, a digital versatile disc, removable flash memory, etc.) that may be coupled to the insurance server 102 to provide access to the computer-readable instructions stored thereon. In particular, the computer-readable instructions stored on the memory 122 may include instructions for executing various applications, such as item replacement determiner 124, item repair determiner 126, and/or machine learning training application 128.

An insurance company that owns the insurance server 102 may provide insurance to the user 170. For example, the insurance company may provide insurance to the user 170 for physical items, such as vehicles, furniture (e.g., either as a stand along policy, or via a homeowners insurance policy, a renters insurance policy, auto insurance policy, personal articles insurance policy, etc.), electronics (e.g., again either as a stand along policy, or via a homeowners insurance policy, a renters insurance policy, auto insurance policy, personal articles insurance policy, etc.), etc. As such, in some situations, it may be useful for the insurance company to provide the user 170 with a set of potential replacement items for an item (e.g., that the user 170 has placed an insurance claim for).

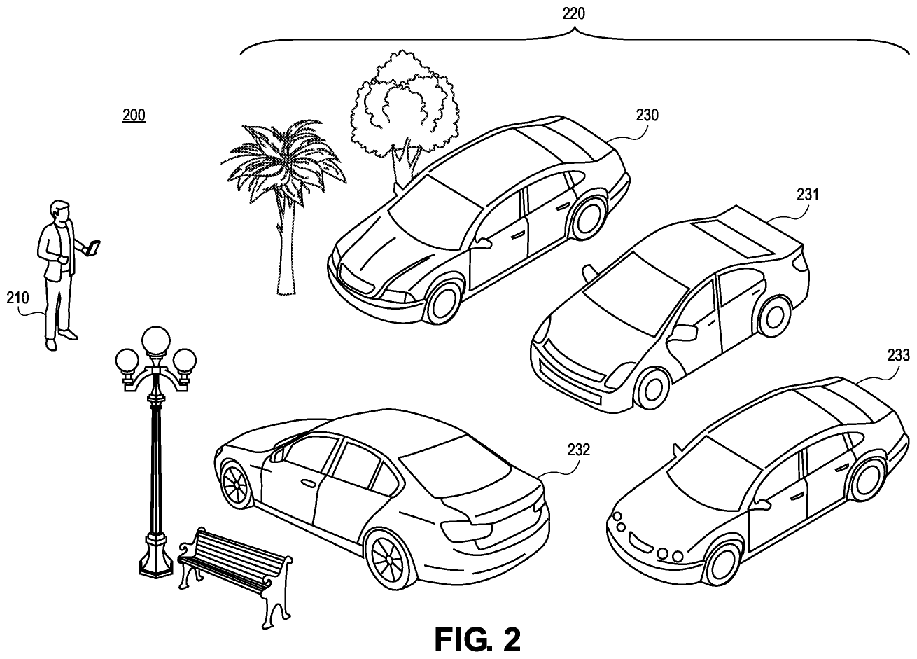

For example, if the user 170 has placed an insurance claim for a loss of a vehicle, the item replacement determiner 124 may determine a set of replacement items (in this example a set of potential replacement vehicles). The set of replacement items may be presented to the user 170 in the virtual environment. For instance, FIG. 2 shows an example environment 200 including a set of potential replacement items 220 being presented to character 210. The potential set of replacement items 220 includes vehicles 230, 231, 232, and 233.

To this end, the item replacement determiner 124 may determine the set of potential replacement items to present to the user 170. The determination may be made based upon any suitable criteria. For example, the determination may be made based upon the type of the physical item (e.g., furniture, electronics, vehicles, etc.), the size of the physical item, the color of the physical item, etc. Furthermore, the determination may be made based on criteria that is specific to the type of the item being replaced. For example, if the item is a vehicle, the determination may be made based on a type of the vehicle (e.g., sedan, sports utility vehicle (SUV), motorcycle, drone, airplane, helicopter, etc.), a size of the vehicle, a color of the vehicle, a year of the vehicle, a make of the vehicle, a model of the vehicle, safety features of the vehicle, etc. In another example, if the physical item is a furniture item, the determination may be made based upon a type of the furniture item, a size of the furniture item, an optional feature of the furniture item (e.g., a color of the furniture item, reclining capabilities of a chair, an add in electronics charger, etc.).

Moreover, the item replacement determiner 124 may determine the set of potential replacement items via any suitable technique. For example, the item replacement determiner 124 may determine the set of potential replacement items by using a trained machine learning algorithm, as will be described further below. In some examples, the machine learning algorithm may be trained by the machine learning training application 128.

To determine the insurance premium and/or train the machine learning algorithm, as will be described further below, the insurance server 102 may receive data from any suitable source, such as the vendor database 180, the external database 190, etc.

In some embodiments, the vendor database 180 is a database of a vendor that sells physical items, such as vehicles (e.g., a car dealership, a store that sells drones, etc.), furniture (e.g., a furniture store, etc.), electronics (e.g., a store that sells electronics, etc.), and so on.

In some embodiments, the external database 190 is a database that holds information of physical items, such as an aggregator database that aggregates information from vendors and/or repair facilities (e.g., aggregates information from construction contractors, automotive repair shops, etc.), a database of a website that rates/evaluates physical items, a government database that regulates physical products, etc. Additionally or alternatively, the external database 190 may hold virtual item information, such as virtual item models for the virtual environment created by the virtual environment server 160, and/or other virtual environments.

Additionally or alternatively to providing a set of potential replacement items to the user 170, the insurance server 102 may provide a set of potential repair options to the user 170. For example, the item repair determiner 126 may determine a set of potential repair options to present to the user 170. In some embodiments, the set of potential repair options comprises repair options from different repair facilities 198, 199. For example, different repair facilities 198, 199 may indicate, to the item repair determiner 126, a price at which they are willing to complete the repair work. The item repair determiner 126 may then use these to build the set of potential repair (and/or replacement) options, and present the set of potential repair (and/or replacement) options (e.g., in the form of a list or in any other form) to the user 170.

In some embodiments, the repair facilities 198, 199 are repair facilities that repair physical items or that plan how to repair physical items. For example, if the item is a home, the repair facilities 198, 199 may be construction contractors, etc. In another example, if the physical item is a vehicle, the repair facilities 198, 199 may be automotive repair shops, etc. In some examples, the set of potential repair options include a first repair option from the repair facility 198, and a second repair option from the repair facility 199. In some such examples, the difference between the first and second repair options is the price, and thus the user 170 is able to select, for example, a lowest bidder for the repair work.

Furthermore, additionally or alternatively to presenting potential repair (and/or replacement) options to the user 170, the item repair determiner 126 may present a damaged version of the physical item to the user 170, which may aid the user 170 in determining if repair is necessary and/or in selecting a repair option. Additionally or alternatively, the item repair determiner 126 may present a virtual version of the physical item to be repaired. For example, if the damage is a small scratch to a vehicle door, seeing virtual representations of both the scratched door and repaired door may help the user 170 determine if the expense of repair is warranted.

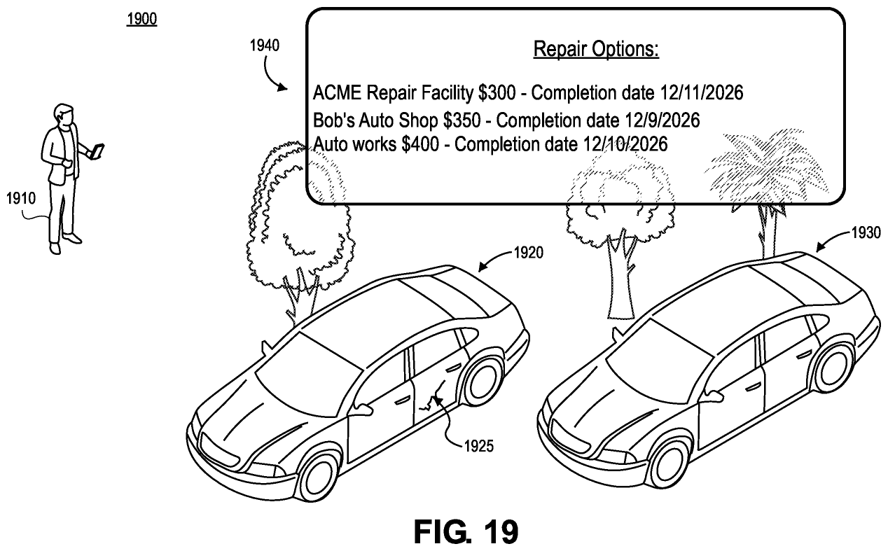

In one such example, FIG. 19 depicts a virtual environment 1900 including a virtual representation of a scratched car 1920 including scratch 1925, and a virtual representation of a car 1930 with the scratch repaired. For example, the virtual representation of the scratched car 1920 may be generated by scanning the scratched physical vehicle to generate a virtual model that represents the damage to the physical vehicle.

In addition, in this example, the user 170 may also control the virtual character 1910 to traverse the virtual environment to aid the user 170 in determining if repair is warranted. For instance, the virtual character 1910 may open a door of the car 1920 to demonstrate what the scratched door looks like while opening, or may travel through the virtual environment 1900 to ask other virtual characters their opinion of the scratch 1910. In another related example (not shown in FIG. 19), the set of potential replacement options presented to the user 170 includes an option to add a scratch-resistant coating to the door to prevent future scratches.

Moreover, the set of potential repair options 1940 may be presented to the user 170. In the illustrated example, the set of repair options comprise prices from repair facilities (e.g., corresponding to repair facilities 198, 199).

It should be appreciated that in some situations, the item repair determiner 126 may determine only one potential repair option to present to the user 170. Thus, in some instances, the set of potential repair options presented to the user 170 may include only one repair option.

In addition, further regarding the example system 100, the illustrated example components may be configured to communicate, e.g., via a network 104 (which may be a wired or wireless network, such as the internet), with any other component. Furthermore, although the example system 100 illustrates only one of each of the components, any number of the example components are contemplated (e.g., any number of users, user devices, virtual environment servers, external databases, vendor databases, insurance servers, repair facilities, etc.).

Exemplary Signal Diagram Illustrations of Exemplary Assistance with Replacement of a Physical Item

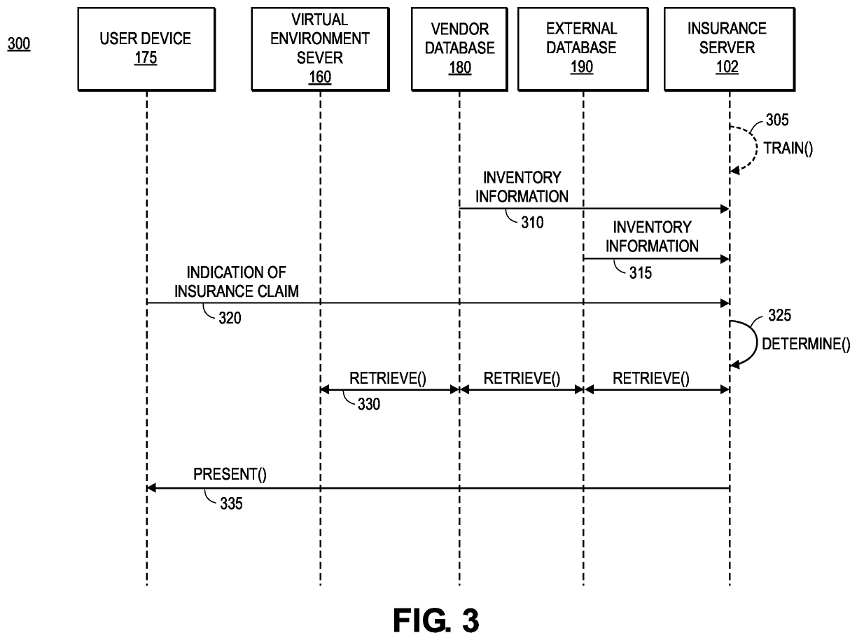

FIG. 3 illustrates an example signal diagram 300 for assisting with replacement of a physical item, according to an embodiment. More particularly, the signal diagram 300 illustrates the signals exchanged and/or detected by various components of a system for assistance with replacement of physical items, such as the example system 100.

The signal diagram 300 may optionally begin when the insurance server 102 (e.g., via the machine learning training application 128) optionally trains (305) a machine learning algorithm to determine sets of replacement items. In other embodiments, another computing entity may train the machine learning algorithm. The machine learning algorithm may be trained based upon historical information retrieved from the insurance database 118 (e.g., from anonymized data of past insurance claims, etc.), or from any other source.

Broadly speaking, the historical information may include information of items that were replaced (e.g., “replaced items”) and/or items that they were replaced with (e.g., “replacement items”). Based upon such historical information, the machine learning algorithm may be trained to find correlations between features in the replaced items and the replacement items, thereby ultimately training the machine learning algorithm to determine potential sets of replacement items for items to be replaced as part of an insurance claim.

More specifically, the machine learning algorithm may be trained using the historical information of replaced items as both inputs (e.g., also referred to as independent variables, or explanatory variables) and outputs (e.g., also referred to as a dependent variables, or response variables).

The historical information of replaced items may include any information of historical physical replaced items (e.g., furniture, electronics, vehicles, etc.). Examples of the historical information include type, size, color, shape, and/or replacement value of the replaced physical item. With respect to electronic items, further examples of the historical information may include historical information of a definition of a display (e.g., type of the display, resolution of the display, etc.) of the replaced physical item. With respect to replaced vehicles, further examples of the historical information may include a year of the replaced vehicle, a make of the replaced vehicle, a model of the replaced vehicle, and/or safety features of the replaced vehicle.

Correspondingly, the historical information of replacement items may include any information of historical physical replacement items (e.g., furniture, electronics, vehicles, etc.). Examples of the historical information include type, size, color, shape, and/or cost of the replacement physical item. With respect to electronic items, further examples of the historical information may include historical information of a definition of a display (e.g., type of the display, resolution of the display, etc.) of the replacement physical item. With respect to replacement vehicles, further examples of the historical information may include a year of the replacement vehicle, a make of the replacement vehicle, a model of the replacement vehicle, and/or safety features of the replacement vehicle.

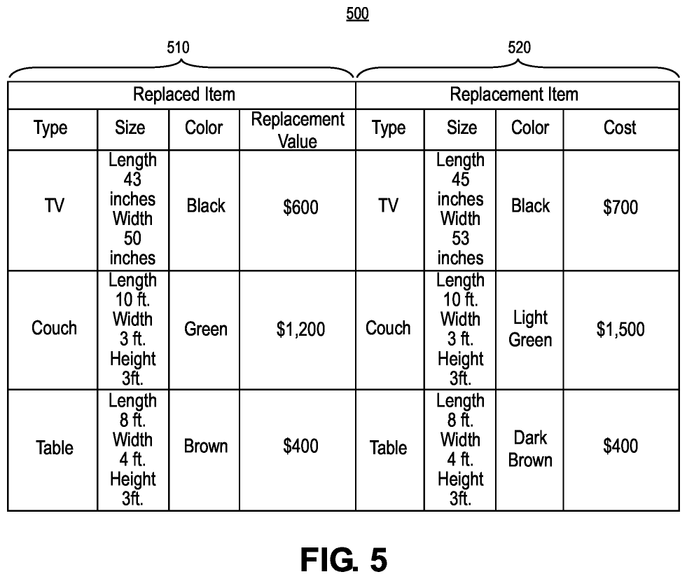

In some embodiments, the historical information of replaced items and/or historical information of replacement items may be in the form of a table, such as the example table 500 of FIG. 5. With reference thereto, the example table 500 includes historical information of replaced items 510, and the corresponding historical information of replacement items 520.

Generally, the machine learning model is trained to identify how each of the input variables may influence the output variables. For example, it may be that there is a very strong correlation between the color of a replaced item, and the color of the replacement item (e.g., users almost always replace black TVs with other black TVs). Or, other correlations may be discovered (e.g., users tend to replace TVs with larger TVs, green couches often replaced with light green couches, etc.).

Additionally, in some embodiments, the insurance server 102 normalizes one or more of the input and/or output variables to, for example, a scale of 0 to 1.

In some embodiments, the machine learning algorithm comprises a neural network (e.g., a neural network trained using the historical information to identify replacement items). In some embodiments, regression techniques are used to predict the replacement cost of the replacement item; for example, the machine learning algorithm may be trained by creating multiple regression models to predict the cost of the replacement item, and then selecting the best regression model (e.g., the regression model with the least error, etc.).

The insurance server 102 may receive (310) inventory information from the vendor database 180. For example, the inventory information may include a listing of the physical items that a vendor corresponding to the vender database has available. The inventory information may further include any information of the listed physical items, such as size, color, shape of the physical item. With respect to electronic items, further examples of the inventory information may include inventory information of a definition of a display of the physical item. With respect to vehicles, further examples of the inventory information may include a year of the vehicle, a make of the vehicle, a model of the vehicle, and/or safety features of the vehicle. The inventory information may also include prices of the physical items.

The inventory information may optionally also include imagery information (e.g., image and/or video information) of the physical item. In some embodiments, the insurance server 102 may analyze the imagery information to derive any of the information (e.g., listed above), such as size, color, shape, etc., of the physical item.

Furthermore, although not shown in the example signal diagram 300, the insurance server 102 may periodically receive updates to the inventory information from the vender database 180, thereby allowing the insurance server to maintain an up-to-date (or mostly up-to-date) listing of what physical items are available from the vender.

The insurance server 102 may also receive (315) inventory information from the external database 190, which may be used to create a listing of physical products available for purchase. As mentioned above, in some embodiments, the external database 190 is a database that holds information of physical items, such as an aggregator database that aggregates information from vendors, a database of a website that rates/evaluates physical items, a government database that regulates physical products, etc. The inventory information received at 315 may be of the same or similar type as received at 310.

Furthermore, although not shown in the example signal diagram 300, the insurance server 102 may periodically receive updates to the inventory information from the external database 190, thereby allowing the insurance server to maintain an up-to-date (or mostly up-to-date) listing of what physical items are available from various sources.

The insurance server 102 may receive (320) an indication of an insurance claim from the user device 175. The indication of the insurance claim may include an indication of a physical item to be replaced. The indication of the physical item to be replaced may include information of the physical item to be replaced, such as type, size, color, and/or shape of the physical item to be replaced. With respect to electronic items, further examples of the information may include information of a definition of a display of the physical item to be replaced. With respect to vehicles, further examples of the information may include a year of the vehicle to be replaced, a make of the vehicle to be replaced, a model of the vehicle to be replaced, and/or safety features of the vehicle to be replaced.

The indication of the insurance claim may optionally also include imagery information (e.g., image and/or video information) of the physical item to be replaced. In some embodiments, the insurance server 102 may analyze the imagery information to derive any of the information (e.g., listed above), such as type, size, color, shape, etc., of the physical item to be replaced.

The insurance server 102 may then determine (325) a set of potential replacement items from the physical item to be replaced. In some embodiments, the determination may be made via the machine learning algorithm trained at 305. For example, the insurance server 102 may route the (i) indication of the physical item (e.g., received at 320) (along possibly with the information of the physical item to be replaced), and (ii) inventory information (e.g., received at 310, 315) to determine the set of potential replacement items.

In some embodiments, the insurance server 102 first analyzes imagery information received at 320 to determine information of the physical item to be replaced (e.g., type, etc., of the physical item to be replaced), and then routes the determined information to the trained machine learning algorithm. Advantageously, this allows the user 170 to, for example, only upload an image of the item to be replaced, thus saving the user 170 time. Moreover, in some implementations, this has the technical advantage that less bandwidth is used. More specifically, rather than send both an image and a description of the physical item to be replaced, only the image is sent from the user device 175 to the insurance server 102, thus saving bandwidth.

Additionally or alternatively, the insurance server may route only specific pieces of information (e.g., determined from the imagery information, or indicated in the information of the physical item to be replaced) into the trained machine learning algorithm. Advantageously, routing fewer pieces of information into the machine learning algorithm may improve run time of the machine learning algorithm. For example, routing information that the physical item is a car with a particular color improves run time over if the routed information is that the physical item is a car with a particular color and has particular safety features.

However, the insurance server 102 may use other techniques as well to determine the set of potential replacement items. For example, the insurance server 102 may use lookup tables to determine the set of replacement items. In one such example, a lookup table that has inputs of the information of the physical item to be replaced (e.g., type, size, color, shape, etc.), and outputs of physical items from the inventory information (e.g., received at 310 and 315) may be used.

In another example, the insurance server 102 may determine the set of potential items by correlating the information of the physical item to be replaced with the inventory information. In one such example, if the information of the physical item to be replaced indicates that the item to be replaced is a green sedan, the set of potential replacement items may be determined to be any or all green sedans available at a vendor. In another example, if the information of the physical item to be replaced indicates that the item to be replaced is a TV, the set of replacement items may include any or all TVs at a vendor that have a screen size within a predetermined tolerance (e.g., 1 inch, 5 inches, 10 inches, etc.) of the TV to be replaced. In yet another example, if the information of the physical item to be replaced indicates that the item to be replaced is a drone, the set of replacement items may include drones with a flight range (e.g., based upon a single battery charge) within a predetermined tolerance of the drone to be replaced. In yet another example, if the information of the physical item to be replaced indicates that the item to be replaced is a SUV, the set of replacement items may include SUVs with a similar gas mileage.

Furthermore, the insurance server 102 may determine a predetermined number of items for the set of potential replacement items (e.g., 1 potential replacement, 2 potential replacement items, 5 potential replacement items, etc.).

In addition, the insurance server may determine an out of pocket cost to the user 170 to buy any of the items of the set of potential replacement items. For example, some insurance policies insure items based upon their present value, not their initial value. For instance, a car may have been initially purchased for $20,000, but after some period of time, when it is destroyed in an accident, it is worth only $10,000. Thus, in this example, an insurance policy might pay only $10,000 to the user 170 following an insurance claim corresponding to the accident. In this regard, the insurance server may calculate out of pocket costs for each vehicle in the potential set of replacements (e.g., based upon the insurance policy, a cost of a replacement vehicle, etc.). Furthermore, the insurance server 102 may determine the set of potential replacement items such that no item in the set of potential replacement items has an out of pocket cost to the user, or such that no item in the set of potential replacement items has an out of pocket cost above a predetermined threshold.

Additionally or alternatively, the insurance server 102 may determine to only use items from a particular vendor in the potential set of replacements. In one such example, the insurance server 102 routes the information received at 310 into the trained machine learning algorithm, and calculates the potential set of replacements without using information from any other vendor. Advantageously, this helps ensure that the information routed into the machine learning algorithm is in only one format, thereby reducing errors in running the machine learning algorithm. This may be combined with the use of the predetermined number of items discussed above (e.g., the information received at 310 includes a list of 50 items of the same type as the item to be replaced, and the machine learning algorithm determines the best 10 from the 50).

Upon determination of the set of potential replacement items, the insurance server 102 may retrieve (330) virtual data of the set of replacement items from the vendor database 180, the external database 190, and/or the virtual environment server 160. The virtual data may comprise any data. For example, the virtual data may comprise virtual item models corresponding to physical items of the set of potential replacement items, and that allow the physical items to be recreated in the virtual environment.

The insurance server 102 then presents (335) the set of potential replacement items to the user 170 (e.g., via the user device 175, etc.). Here, although the example signal diagram 300 shows the presentation as being made from the insurance server 102 to the user device, it should be understood that, in some embodiments, the insurance server 102 may instead send an indication to the virtual environment server 160 so that the virtual environment server 160 makes the presentation to the user 170.

The presentation may be made in any suitable form. For instance, as in the example of FIG. 2, the user 170 may use a character 210 to view a potential set of replacement items 220, which, in the illustrated example, is a set of cars.

In some examples, the user 170 may use items of the set of potential replacement items in the virtual environment to help make a decision of which item to select. For example, if the physical item to be replaced is a piece of furniture or an electrical item, the user 170 may set up a virtual home including the physical item to be replaced so to help the user 170 visualize potential replacement items in a home.

Moreover, in the virtual environment, the out of pocket cost to the customer 170 (e.g., calculated at 325) may be displayed for any of items of the set of potential replacement items as well.

Furthermore, if the physical item to be replaced is a vehicle, the user may opt to test drive vehicles of the set of replacements in the virtual environment. For example, the user 170 may use the user device 175 to test dive the vehicle in the virtual environment. In some such examples, the user device 175 comprises, for example, a VR headset (e.g., controlled by VR gloves), a videogame console, a mock steering wheel, a mock acceleration pedal, a mock brake pedal, etc.

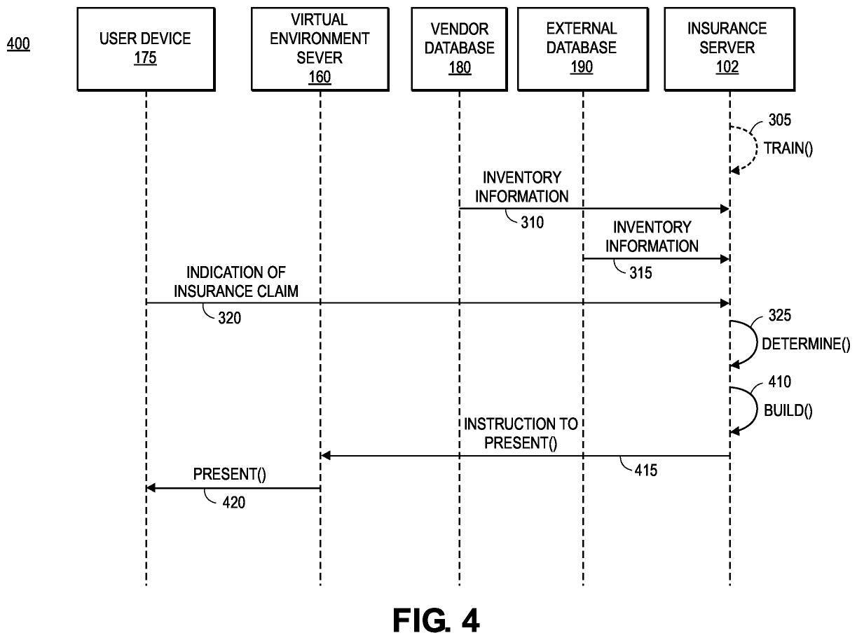

FIG. 4 depicts an exemplary signal diagram for assisting with replacement of a physical item, including building virtual item models. Whereas the signal diagram 300 of FIG. 3 shows an example that does not include building a virtual item model, the signal diagram 400 FIG. 4 shows an example that includes building a virtual item model. To further explain, broadly speaking, some potential physical replacement items may not have corresponding virtual items. For example, the insurance server may determine a set of replacements, but there is no virtual data corresponding to one or more items of the set of replacements. As such, in some embodiments, the insurance server 102 may build virtual item models of items of the set of potential replacement items, and send the virtual item models to the virtual environment server 160, thereby allowing the virtual environment server to present the suggested replacements to the user 170.

To this end, FIG. 4 illustrates an example signal diagram 400 for assisting with replacement of a physical item, including building virtual item models, according to an embodiment. More particularly, the signal diagram 400 illustrates the signals exchanged and/or detected by various components of a system for assistance with replacement of physical items, such as the example system 100.

The example signal diagram 400 may begin with events 305-325 occurring substantially as in the example signal diagram 300. The insurance server 102 then builds (410) virtual item models. The virtual item models may be built in a format operable to import virtual versions of the virtual items into the virtual environment.

The virtual item models may be built using any suitable criteria. For example, the virtual item models may be built such that the virtual versions of the physical items have similar size and/or color to the physical items. If the item is an electronic item, the virtual item model may be, additionally or alternatively, built such that the virtual version of the physical item has a similar definition of a display of the electronic item. If the item is a vehicle, the virtual item model may be, additionally or alternatively, built such that the virtual version of the physical vehicle has a similar vehicle: type, size, color, year, make, model, and/or safety features to the physical vehicle. In some embodiments, the insurance server builds the virtual item models based upon imagery data (e.g., image data or video data) received from the vender database 180 and/or the external database 190. For example, the insurance server 102 may analyze the imagery data to determine a type, size, and/or color of the physical item, and then build the virtual item model based upon the determined type, size, and/or color.

The building of the virtual item models at the insurance server 102 has technical advantages. For example, computational resources are saved at the virtual environment server 160 (e.g., because the models are being built at the insurance server 102, rather than the virtual environment server 160), which is advantageous because the virtual environment server 160 is already spending large amounts of computational resources to produce the virtual environment.

The insurance server 102 may then send (415) an instruction to present the set of potential replacement items to the user. The sent instruction may include the virtual item models built at 410.

The virtual environment server 160 may then present (420) (e.g., using the virtual item models) the potential set of replacements to the user 170 (e.g., as in the example of FIG. 2, etc.).

However, in some embodiments, due to the large amount of computational resources that may be required to build the virtual item models, it is advantageous to not build virtual item models of every item in the set of potential replacement items. As such, in some embodiments, following the determination of the set of potential replacement items at 325, the insurance server 102 sends a list of the items of the set of potential replacement items to the user device 175 (which may display the list in the virtual environment, or simply display the list on a display of the user device 175). The user device 175 may then send a selection from the user 170 from the list to the insurance server 102. The insurance server 102 may then build models of only the selected items.

In one such example, the virtual items are vehicles, and the insurance server 102 sends the user device 175 a list of potential replacement vehicles along with a question asking if the user 170 would like to test drive the vehicles in the virtual environment. The user 170 then selects vehicles she would like to test drive and the user device 175 then sends the selection to the insurance server 102. The insurance server 102 then builds (410) the selected vehicles so that the user 170 may test drive them in the virtual environment.

It should be understood that not all blocks and/or events of the exemplary signal diagrams and/or flowcharts are required to be performed. Moreover, the exemplary signal diagrams and/or flowcharts are not mutually exclusive (e.g., block(s)/events from each example signal diagram and/or flowchart may be performed in any other signal diagram and/or flowchart). The exemplary signal diagrams and/or flowcharts may include additional, less, or alternate functionality, including that discussed elsewhere herein.

Exemplary Methods for Assisting with Replacement of a Physical Item

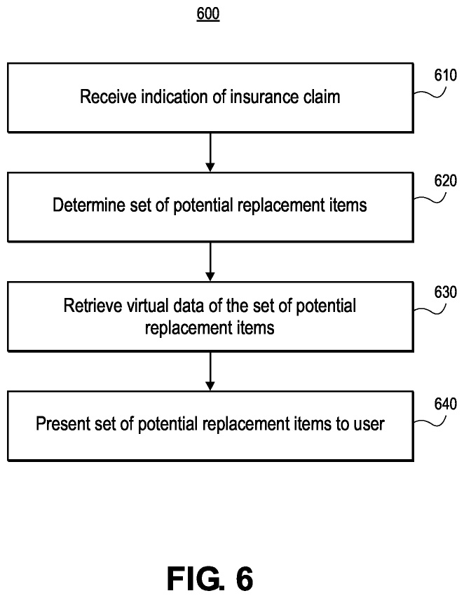

FIG. 6 shows an exemplary computer-implemented method or implementation 600 of assisting with replacement of a physical item. The exemplary implementation 600 may begin at block 610 when the one or more processors 120 receive an indication of an insurance claim. The indication may (i) include an indication of a physical item to be replaced, and (ii) arise from a virtual environment.

At block 620, the one or more processors 120 may determine a set of potential replacement items for the physical item to be replaced.

At block 630, the one or more processors 120 may retrieve virtual data of the set of potential replacement items.

At block 640, the one or more processors 120 may present based, upon the retrieved virtual data of the set of potential replacement items, the set of potential replacement items to a user 170. For example, the one or more processors 120 may send an instruction to the virtual environment server 160 to present the set of potential replacement items to the user 170.

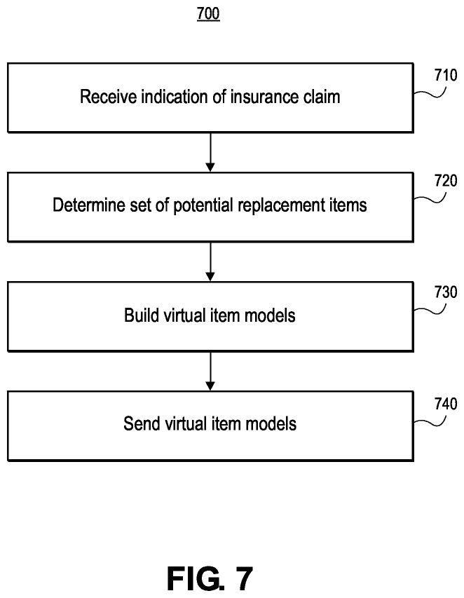

FIG. 7 shows an exemplary computer-implemented method or implementation 700 of assisting with replacement of a physical item, including building virtual item models. The exemplary implementation 700 may begin at block 710 when the one or more processors 120 receive an indication of an insurance claim. The indication may (i) include an indication of a physical item to be replaced, and (ii) arise from a virtual environment.

At block 720, the one or more processors 120 may determine a set of potential replacement items for the physical item to be replaced.

At block 730, the one or more processors 120 may build virtual item models of items of the set of potential replacement items in a format operable to import virtual versions of the items of the set of potential replacement items into the virtual environment.

At block 740, the one or more processors 120 may send the virtual item models to the virtual environment server 160. The virtual item models may be sent along with an instruction to present the set of potential replacement in the virtual environment to the user 170.

It should be understood that not all blocks and/or events of the exemplary signal diagrams and/or flowcharts are required to be performed. Moreover, the exemplary signal diagrams and/or flowcharts are not mutually exclusive (e.g., block(s)/events from each example signal diagram and/or flowchart may be performed in any other signal diagram and/or flowchart). The exemplary signal diagrams and/or flowcharts may include additional, less, or alternate functionality, including that discussed elsewhere herein.

Additional Exemplary Embodiments for Assisting with Replacement of a Physical Item

In one aspect, a computer-implemented method for assisting with replacement of a physical item may be provided. The method may be implemented via one or more local or remote processors, servers, transceivers, sensors, memory units, storage devices, virtual reality headsets, smart glasses, augmented reality headsets or glasses, wearables, mobile devices, smart watches, smart devices, and/or other electronic or electric components. For instance, the method may include: (1) receiving, via one or more processors, an indication of an insurance claim, wherein the indication of the insurance claim: (i) includes an indication of a physical item to be replaced, and (ii) arises from a virtual environment; (2) determining, via the one or more processors, a set of potential replacement items for the physical item to be replaced; (3) retrieving, via the one or more processors, virtual data of the set of potential replacement items; and/or (4) presenting, via the one or more processors, in the virtual environment, and based upon the retrieved virtual data of the set of potential replacement items, the set of potential replacement items to a user. The computer system may include additional, less, or alternate functionality, including that dis-cussed elsewhere herein.

In some embodiments, the physical item to be replaced may include a personal article, or a vehicle. In certain embodiments, the physical item may include a furniture item, and/or determining the set of potential replacement items comprises: determining, via the one or more processors, the set of potential replacement items based upon a type of the furniture item, a size of the furniture item, and/or an optional feature of the furniture item.

In some embodiments, the physical item may include an electronic item, and/or determining the set of potential replacement items may include: determining, via the one or more processors, the set of potential replacement items based upon a type of the electronic item, a size of the electronic item, and/or a color of the electronic item.

In some embodiments, the physical item may include a vehicle, and/or determining the set of potential replacement items may include: determining, via the one or more processors, the set of potential replacement items based upon a type of the vehicle, a size of the vehicle, a color of the vehicle, a year of the vehicle, a make of the vehicle, a model of the vehicle, and/or features of the vehicle.

In some embodiments, the physical item may include a vehicle, and/or the method further may include: receiving, via the one or more processors and from a user device associated with the user, an indication that the user would like to virtually test drive a replacement vehicle included in the set of potential replacement items; and/or sending, via the one or more processors, a request to a virtual environment server to provide a virtual item corresponding to the replacement vehicle within the virtual environment.

In some embodiments, presenting the potential replacement items includes: calculating, via the one or more processors, a price of items included in the set of potential replacement items based upon: (i) an insurance policy corresponding to the insurance claim, (ii) a current value of the physical item to be replaced, and/or (iii) current prices of the items of the set of potential replacement items; and/or presenting, via the one or more processors, the set of potential replacement items the corresponding calculated prices to the user.

In some embodiments, analyzing, via the one or more processors, an insurance policy corresponding to the insurance claim to identify a replacement budget; and/or generating, via the one or more processors, the set of potential replacement items such that a total replacement cost for the set of potential replacement items is within the replacement budget.

In some embodiments, the determining the set of potential replacement items may include: routing, via the one or more processors, the indication of the physical item to be replaced to a machine learning algorithm that is: (i) trained using historical information of physical items, and historical information of insurance customers, and/or (ii) configured to output suggested replacement items to include in the set of potential replacement items.

In some embodiments, the determining the set of potential replacement items may include: determining, via the one or more processors, a type of the physical item to be replaced by analyzing imagery data corresponding to the physical item to be replaced; routing, via the one or more processors, the determined type to a machine learning algorithm that is: (i) trained using historical information of physical items, and/or historical information of insurance customers, and/or (ii) configured to output to output suggested replacement items to determine the set of potential replacement items.

In some embodiments, determining the set of potential replacement items may include: receiving, via the one or more processors and from a vender server, an inventory list that includes items matching an item type associated with the physical item to be replaced; and/or potential replacement items populating, via the one or more processors, the set of potential replacement items the matching items included in the inventory list.

In another aspect, a computer-implemented method for assisting with replacement of a physical item may be provided. The method may be implemented via one or more local or remote processors, servers, transceivers, sensors, memory units, storage devices, virtual reality headsets, smart glasses, augmented reality headsets or glasses, wearables, mobile devices, smart watches, smart devices, and/or other electronic or electric components. For instance, the method may include: (1) receiving, via one or more processors, an indication of an insurance claim, wherein the indication of the insurance claim: (i) includes an indication of a physical item to be replaced, and/or (ii) arises from a virtual environment; (2) determining, via the one or more processors, a set of potential replacement items for the physical item to be replaced; (3) building, via the one or more processors, virtual item models of items of the set of potential replacement items in a format operable to import virtual versions of the items of the set of potential replacement items into the virtual environment; and/or (4) sending, via the one or more processors, to a virtual environment server: (i) an instruction to present the set of potential replacement items in the virtual environment, and/or (ii) the virtual item models. The method may include additional, fewer, or alternate actions, including those discussed else-where herein.

In some embodiments, the method may further include: sending, via the one or more processors and to a user device, a list including items of the set of potential replacement items; and/or receiving, via the one or more processors and from the user device, a selection of items from the list. The building of the virtual item models may include building virtual item models of items selected from the list.

In some embodiments, the physical item may include a vehicle, and the method further may include: sending, via the one or more processors and to a user device associated with a user: (i) a list including vehicles of the set of potential replacement items, and/or (ii) a question asking if the user would like to virtually test drive a vehicle; and/or receiving, via the one or more processors and from the user device, a selection of a vehicle from the list along with an indication that the user would like to virtually test drive the vehicle; and/or the building of the virtual item models may include building a virtual model of the vehicle selected from the list.

In some embodiments, the physical item to be replaced may include a personal article, or a vehicle.

In another aspect, a computer system configured to assist with replacement of a physical item may be provided. The computer system may include one or more local or remote processors, servers, transceivers, sensors, memory units, storage devices, virtual reality headsets, smart glasses, augmented reality headsets or glasses, wearables, mobile devices, smart watches, smart devices, and/or other electronic or electric components. For instance, the computer system may include one or more processors configured to: (1) receive an indication of an insurance claim, wherein the indication of the insurance claim: (i) includes an indication of a physical item to be replaced, and/or (ii) arises from a virtual environment; (2) determine a set of potential replacement items for the physical item to be replaced; (3) retrieve virtual data of the set of potential replacement items; and/or (4) present, in the virtual environment, and based upon the retrieved virtual data of the set of potential replacement items, the set of potential replacement items to a user. The computer system may include additional, less, or alternate functionality, including that dis-cussed elsewhere herein.

In some embodiments, the physical item to be replaced may include a furniture item, an electronic item, or a vehicle. In certain embodiments, the physical item may include a furniture item, and the one or more processors are configured to determine the set of potential replacement items by determining the set of potential replacement items based upon a type of the furniture item, a size of the furniture item, and/or optional feature of the furniture item.

In some embodiments, the physical item may include an electronic item, and the one or more processors are configured to determine the set of potential replacement items by determining the set of potential replacement items based upon a type of the electronic item, a size of the electronic item, and/or a color of the electronic item.

In some embodiments, the physical item may include a vehicle and the one or more processors are configured to determine the set of potential replacement items by determining the set of potential replacement items based upon a type of the vehicle, a size of the vehicle, a color of the vehicle, a year of the vehicle, a make of the vehicle, a model of the vehicle, and/or safety features of the vehicle.

Exemplary Signal Diagram Illustrations of Exemplary Assistance with Repair of a Physical Item

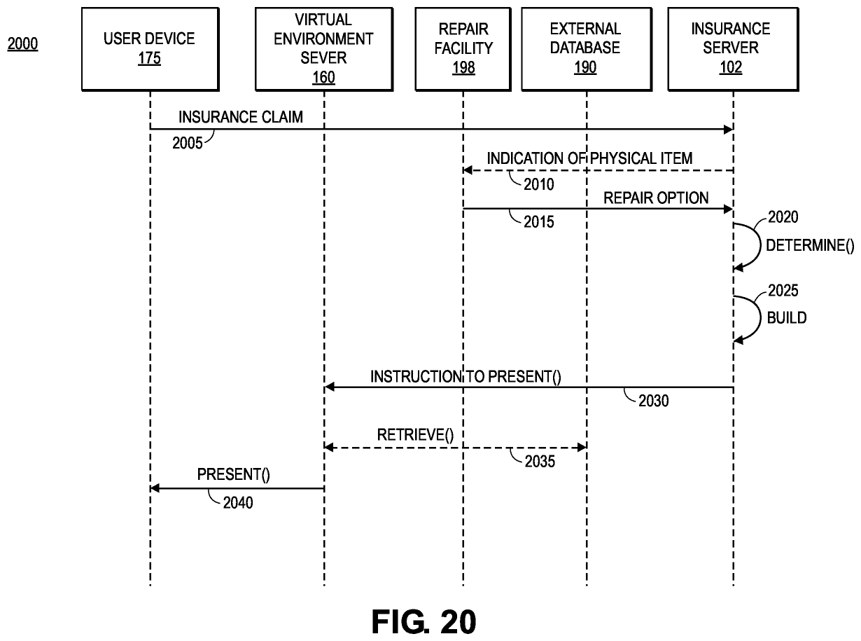

FIG. 20 illustrates an example signal diagram 2000 for assisting with repair of a physical item, according to an embodiment. More particularly, the signal diagram 2000 illustrates the signals exchanged and/or detected by various components of a system for assistance with repair (and/or replacement) of physical items, such as the example system 100.

The signal diagram 2000 may begin when the insurance server 102 receives (2005) an indication of an insurance claim from the user device 175. The indication of the insurance claim may include an indication of a physical item to be repaired (and/or replaced) and/or an indication of physical damage to the physical item to be repaired (and/or replaced). The insurance claim may correspond to an insurance policy for the physical item itself (e.g., a vehicle covered by car insurance). Additionally or alternatively, the insurance claim may correspond to an insurance policy that broadly covers a variety of physical items, including the physical item (e.g., homeowners insurance policy covering personal articles).

The indication of the insurance claim may also include imagery data (e.g., image and/or video data) of the physical item to be repaired (and/or replaced). In some embodiments, the insurance server 102 may analyze the imagery data to derive any of the information (e.g., listed above), such as type, part, size, color, shape, etc., of the physical item to be repaired (and/or replaced).

Additionally or alternatively, the indication of the physical item to be repaired may include information of the physical item to be repaired, such as type, size, color, and/or shape of the physical item to be repaired. Additionally or alternatively, the information of the physical item may include a part of the physical item to be repaired (e.g., a floor of a house, a wall of a house, a roof of a house a bumper of a vehicle, door of a vehicle, a windshield or window of a vehicle, etc.).

The insurance server 102 may then optionally send (2010) an indication of the physical item to the repair facility 198. As mentioned above, the repair facility 198 may be any facility suitable for repairing the physical item, or suggesting potential repair options for the physical item. Examples of the repair facility include a construction contractor, an automotive repair shop, etc. However, it should be appreciated that this event is optional. For instance, is some examples, the user 170 instead brings the physical item to the repair facility 198. Additionally or alternatively, the user device 175 may send the indication of the physical item to be repaired to the repair facility 198.

The repair facility 198 may then send (2015) a repair option for the physical item to be repaired to the insurance server 102. For example, the repair facility 198 may send a repair option including a price for repairing the physical item and/or a completion date for completing the repair work. Additionally or alternatively, the repair facility 198 may send a list of risks for failing to repair the damage. For example, if the damage is to a roof, the list may include an increased risk of water damage and/or electrical fire damage.

The insurance server 102 may then determine (2020) the set of potential repair options. For example, if the insurance server 102 has received only one repair option, the set of potential repair options may be determined to be only the one repair option. Alternatively, if the insurance server 102 has received a plurality of repair options, the insurance server 102 may determine the set of potential repair options in any suitable way. In one example, the insurance server may determine the set of potential repair options to be every repair option received. In another example, the set of potential repair options may be any received repair options below or above a predetermined price threshold. In another example, the set of potential repair options may be the repair options that are completed within a predetermined time period or before a predetermined date.

Moreover, the insurance server 102 may also determine the out of pocket costs to the user 170 for the set of potential repair options as well. In some examples, the insurance server 102 calculates the out of pocket cost to the user 170 based upon: (i) the prices sent by the repair facility 198, and/or (ii) insurance policy information. For example, the insurance server 102 may subtract a deductible of an insurance policy from the price sent by the repair facility 198 to calculate the out of pocket cost for a repair option.

The insurance server 102 may then build (2025) a virtual model of the physical item to be repaired. For example, the insurance server 102 may build a virtual model of the car 1920 including the scratch 1925. The virtual model may be built by any suitable technique. For example, the insurance server may use the imagery data (e.g., received at event 2005, etc.) to build the model. In some examples, this includes the insurance server 102 analyzing the imagery data to determine dimensions of the damage (e.g., height, length, and/or width of the damage). For example, the dimensions of the scratch 1925, a hole in a roof, etc. may be determined. The imagery data may also be analyzed to determine color, and/or texture of the physical item to be repaired.

The insurance server 102 then sends, to the virtual environment server 160, an instruction to present (2030) the set of potential repair options to the user 170 (e.g., via the user device 175, etc.). The instruction to present may include the determined set of potential repair options, the indication of the physical item to be repaired, and/or the virtual model of the repaired version of the physical item to be repaired.

The virtual environment server 160 may then optionally retrieve (2035) a repaired version of the physical item to be repaired. It should be appreciated that, in some embodiments, the repaired version of the physical item is the “normal” version of the item, and thus a virtual model of the item may be held at the external database 190, the virtual environment server 160, etc. Furthermore, in some embodiments, for example where the virtual model of the repaired version of the item is held at the virtual environment server 160, event 2035 is not required to be performed.

In some alternative embodiments, the insurance server 102 may build a virtual model of a repaired version of the physical item to be repaired. For example, the insurance server 102 may build a virtual model of the car 1930. The virtual model may be built by any suitable technique. For example, the insurance server may use the imagery information (e.g., received at event 2005, etc.) to build the model. In some examples, the insurance server 102 uses the determined dimensions of the damage, determined color of the item, and/or determined texture of the item to build the model. For example, the insurance server 102 may use the determined color and/or texture to fill over the damage to produce the model of the repaired version. In some such embodiments, the built virtual model of a repaired version of the physical item to be repaired may be sent at 2030, and thus 2035 would not be required to be performed.

The virtual environment server 160 may then present (2040), in the virtual environment, the set of potential repair options, the physical item to be repaired, and/or the repaired version of the physical item to be repaired to the user 170. In some examples, the virtual environment server 160 may generate an animation depicting the damage to the physical item, and how the repair option addresses the damage (e.g., an animation depicting the repair of the physical item).

However, in some alternative embodiments, the insurance server 102 presents directly to the user device 102. That is, rather than perform event 2035, the insurance server 102 directly presents in the virtual environment, the set of potential repair options, the physical item to be repaired, and/or the repaired version of the physical item to be repaired to the user 170.

Moreover, during the presentation, in the virtual environment, the out of pocket costs to the user 170 (e.g., determined at 2020) may be displayed for the set of potential repair options as well.

In some embodiments, the dimensions of the damage are overlaid onto the presented damage. For example, the dimensions of the scratch 1925 may be displayed during the presentation.

Additionally or alternatively, the insurance server 102 may present a list of increased risks for failing to repair the damage. For example, if the damage is to a roof, the list may include an increased risk of water damage and/or electrical fire damage.

Additionally or alternatively, replacement option(s) may be presented to the user 170. The replacement options may be determined by any of the techniques discussed herein (e.g., with respect to FIGS. 1-7, etc.).

It should be understood that not all blocks and/or events of the exemplary signal diagrams and/or flowcharts are required to be performed. Moreover, the exemplary signal diagrams and/or flowcharts are not mutually exclusive (e.g., block(s)/events from each example signal diagram and/or flowchart may be performed in any other signal diagram and/or flowchart). The exemplary signal diagrams and/or flowcharts may include additional, less, or alternate functionality, including that discussed elsewhere herein.

Exemplary Methods for Assisting with Repair of a Physical Item

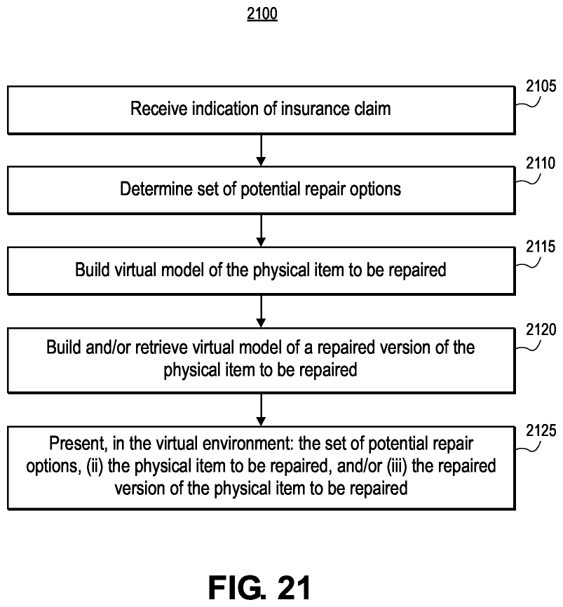

FIG. 21 shows an exemplary computer-implemented method or implementation 2100 of assisting with repair of a physical item. The exemplary method or implementation 2100 may begin at block 2105 when the one or more processors 120 receive an indication of an insurance claim. The indication may (i) include an indication of a physical item to be repaired (and/or replaced), (ii) arise from a virtual environment, and/or (iii) include an indication of damage to the physical item to be repaired (and/or replaced).

At block 2110, the one or more processors 120 may determine a set of potential repair options for the physical item to be repaired.

At block 2115, the one or more processors 120 may build a virtual model of the physical item to be repaired.

At block 2120, the one or more processors 120 may optionally build and/or retrieve a virtual model of the repaired version of the physical item to be repaired. Additionally or alternatively, the virtual environment server 160 may retrieve the virtual model of the repaired version of the physical item to be repaired from the external database 190.

At block 2125, the one or more processors 120 may present (e.g., to the user 170), in the virtual environment: the set of potential repair options, (ii) the physical item to be repaired, and/or (iii) the repaired version of the physical item to be repaired. For example, the one or more processors 120 may send an instruction to the virtual environment server 160 to make the presentation in the virtual environment.

It should be understood that not all blocks and/or events of the exemplary signal diagrams and/or flowcharts are required to be performed. Moreover, the exemplary signal diagrams and/or flowcharts are not mutually exclusive (e.g., block(s)/events from each example signal diagram and/or flowchart may be performed in any other signal diagram and/or flowchart). The exemplary signal diagrams and/or flowcharts may include additional, less, or alternate functionality, including that discussed elsewhere herein.

Additional Exemplary Embodiments for Assisting with Repair of a Physical Item

In one aspect, a computer-implemented method for assisting with repair of a physical item may be provided. The method may be implemented via one or more local or remote processors, sensors, transceivers, servers, memory units, augmented reality glasses or headsets, extended or virtual reality headsets, smart glasses or watches, wearables, and/or other electronic or electrical components. In one aspect, the method may include: (1) receiving, via one or more processors, an indication of an insurance claim, wherein the indication of the insurance claim: (i) includes an indication of a physical item to be repaired, and (ii) arises from a virtual environment; (2) determining, via the one or more processors, a set of potential repair options for the physical item to be repaired; (3) building, via the one or more processors, virtual model of the physical item to be repaired; and/or (4) presenting, via the one or more processors, in the virtual environment: (i) a representation of the physical item to be repaired based upon the virtual model of the physical item to be repaired, (ii) a virtual representation of a repaired version of the physical item to be repaired based upon the virtual model of the physical item to be repaired, and/or (iii) the set of potential repair options to a user. The method may include additional, fewer, or alternate actions, including those discussed elsewhere herein.

In some embodiments, the physical item to be repaired comprises a home, a vehicle, or a personal article.

In some embodiments, wherein the determining the set of potential repair options comprises: sending, via the one or more processors, the indication of the physical item to be repaired to one or more processors of a repair facility; receiving, via the one or more processors, and from the one or more processors of the repair facility, a repair option; and/or adding, via the one or more processors, the repair option to the set of potential repair options.

In some embodiments, the one or more processors receive the repair option along with a price of the repair option, and/or the presenting further comprises presenting, via the one or more processors, the price of the repair option to the user.

In some embodiments, the received indication of the insurance claim further (iii) includes imagery data of the physical item to be repaired; and/or the building the virtual model of the physical item to be repaired comprises building, via the one or more processors, the virtual model of the physical item to be repaired based upon the imagery data of the physical item to be repaired.

In some embodiments, the method further including building the virtual model of the physical item to be repaired based upon dimensions of damage determined from the imagery data.

In some embodiments, the physical item comprises a home; and/or the presenting further comprises presenting, via the one or more processors, in the virtual environment, a list of increased risks for failing to repair the damage to the home including: an increased risk of water damage, and/or an increased risk of electrical fire damage.

In some embodiments, the presenting further comprises presenting, via the one or more processors, in the virtual environment, a replacement option for replacing the physical item to be repaired.

In another aspect, a computer system configured to assist with repair of a physical item may be provided. The computer system may include one or more local or remote processors, sensors, transceivers, servers, memory units, augmented reality glasses or headsets, extended or virtual reality headsets, smart glasses or watches, wearables, and/or other electronic or electrical components. In one aspect, the computer system may include one or more processors configured to: (1) receive an indication of an insurance claim, wherein the indication of the insurance claim: (i) includes an indication of a physical item to be repaired, and (ii) arises from a virtual environment; (2) determine a set of potential repair options for the physical item to be repaired; (3) build virtual model of the physical item to be repaired; and/or (4) present, in the virtual environment: (i) a representation of the physical item to be repaired based upon the virtual model of the physical item to be repaired, (ii) a virtual representation of the repaired version of the physical item to be repaired based upon the virtual model of the physical item to be repaired, and (iii) the set of potential repair options to a user. The computer system may include additional, less, or alternate functionality, including that discussed elsewhere herein.

In some embodiments, the physical item to be replaced comprises a home, a vehicle, or a personal article.

In some embodiments, the one or more processors are configured to determine the set of potential repair options by: sending the indication of the physical item to be repaired to one or more processors of a repair facility; receiving and from the one or more processors of the repair facility, a repair option; and/or adding the repair option to the set of potential repair options.

In some embodiments, the one or more processors are configured to receive the repair option along with a price of the repair option, and wherein the one or more processors are configured to present the price of the repair option to the user.

In some embodiments, the received indication of the insurance claim further (iii) includes imagery data of the physical item to be repaired; and/or the one or more processors are further configured to build the virtual model of the physical item to be repaired by building the virtual model of the physical item to be repaired based upon the imagery data of the physical item to be repaired.

In some embodiments, the one or more processors are further configured to build the virtual model of the physical item to be repaired by building the virtual model of the physical item to be repaired based upon dimensions of damage determined from the imagery data.

In some embodiments, the physical item comprises a home; and/or the one or more processors are configured to present, in the virtual environment, a list of increased risks for failing to repair the damage to the home including: an increased risk of water damage, and/or an increased risk of electrical fire damage.

In some embodiments, the one or more processors are configured to present, in the virtual environment, a replacement option for replacing the physical item to be repaired.

In yet another aspect, a computer device configured to assist with repair of a physical item may be provided. The computer device may include: one or more processors; and/or one or more memories coupled to the one or more processors. The one or more memories including computer executable instructions stored therein that, when executed by the one or more processors, cause the one or more processors to: (1) receive an indication of an insurance claim, wherein the indication of the insurance claim: (i) includes an indication of a physical item to be repaired, and (ii) arises from a virtual environment; (2) determine a set of potential repair options for the physical item to be repaired; (3) build virtual model of the physical item to be repaired; and/or (4) present, in the virtual environment: (i) a representation of the physical item to be repaired based upon the virtual model of the physical item to be repaired, (ii) a virtual representation of a repaired version of the physical item to be repaired based upon the virtual model of the physical item to be repaired, and (iii) the set of potential repair options to a user. The computer device may include additional, less, or alternate functionality, including that discussed elsewhere herein.

In some embodiments, the physical item to be repaired comprises a home, a vehicle, or a personal article.

In some embodiments, the one or more memories including computer executable instructions stored therein that, when executed by the one or more processors, further cause the one or more processors to determine the set of potential repair options by: sending the indication of the physical item to be repaired to one or more processors of a repair facility; receiving and from the one or more processors of the repair facility, a repair option; and/or adding the repair option to the set of potential repair options.

In some embodiments, the one or more memories including computer executable instructions stored therein that, when executed by the one or more processors, further cause the one or more processors to receive the repair option along with a price of the repair option, and wherein the one or more memories including computer executable instructions stored therein that, when executed by the one or more processors, further cause the one or more processors to present the price of the repair option to the user.

### Exemplary System for Insurance of a Non-Fungible Token (NFT)

Broadly speaking, an NFT is a record on a distributed ledger which may be associated with (e.g., represent ownership on the distributed ledger, etc.) of a digital asset (e.g., an image, a video, an audio recording, etc.), and/or a physical asset (e.g., real estate, a vehicle, etc.). However, in certain situations, the NFT may become compromised (e.g., the distributed ledger is hacked, etc.). To remedy and/or mitigate this, embodiments disclosed herein provide techniques for insurance of NFTs.

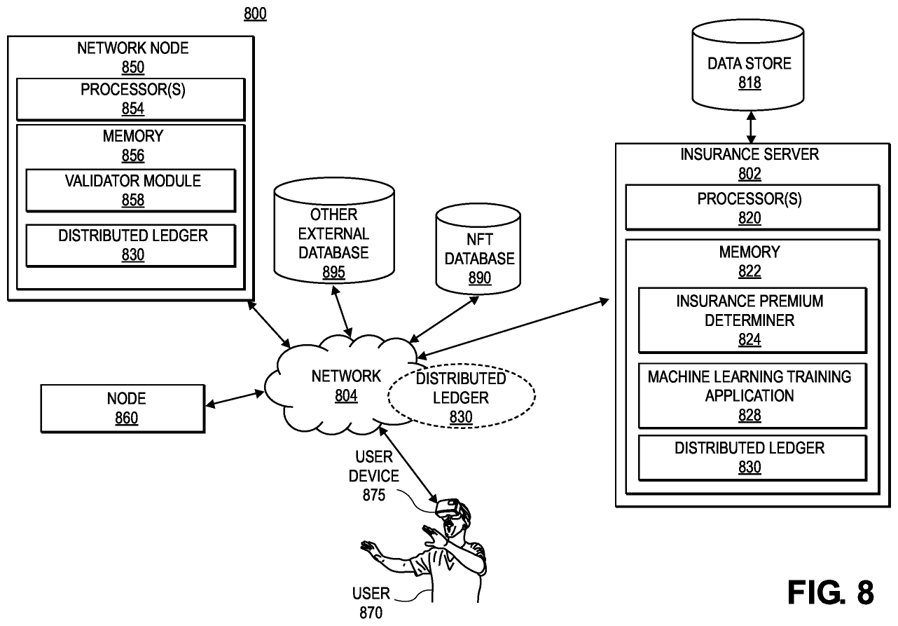

FIG. 8 shows an exemplary computer system 800 for insurance of an NFT in which the exemplary computer-implemented methods described herein may be implemented. The high-level architecture includes both hardware and software applications, as well as various data communications channels for communicating data between the various hardware and software components.

The premiums for the insurance of the NFT may be determined by the insurance server 802. In some embodiments, the insurance server 802 is also a node on the distributed ledger 830.

The insurance server 802 may include one or more processors 820 such as one or more microprocessors, controllers, and/or any other suitable type of processor. The insurance server 802 may further include a memory 822 (e.g., volatile memory, non-volatile memory) accessible by the one or more processors 820, (e.g., via a memory controller). The one or more processors 820 may interact with the memory 822 to obtain and execute, for example, computer-readable instructions stored in the memory 822. Additionally or alternatively, computer-readable instructions may be stored on one or more removable media (e.g., a compact disc, a digital versatile disc, removable flash memory, etc.) that may be coupled to the insurance server 802 to provide access to the computer-readable instructions stored thereon. In particular, the computer-readable instructions stored on the memory 822 may include instructions for executing various applications, such as insurance premium determiner 824, and/or machine learning training application 828.

An insurance company that owns the insurance server 802 may provide insurance to the user 870. For instance, the insurance company may provide insurance to the user 870 for an NFT, for example, that represents ownership of a digital asset (e.g., an image, a video, an audio recording, etc.), and/or a physical asset (e.g., real estate, a vehicle, etc.).

For example, the user 870 may own an NFT, which may be a record on the distributed ledger 830. The NFT may indicate ownership of a digital asset or physical asset. If the asset is a digital asset, the NFT may also contain a reference to a link to a storage location that stores the digital asset, such as a storage location in NFT database 890. Additionally or alternatively, in certain scenarios, if the asset is a physical asset, the NFT may also contain a reference to a link to a storage location, such as a storage location in NFT database 890 (e.g., the physical asset is real estate, and the NFT database 890 stores the property deed).

In operation, and as will be further described elsewhere herein, the insurance premium determiner 824 may determine an insurance premium for the NFT based upon an insurability metric, such as: (i) a reliability rating of the distributed ledger, (ii) a uniqueness rating of the digital asset, (iii) a historical price paid for the NFT, (iv) prices paid for other NFTs on the distributed ledger, (v) a length of time the NFT has existed, and/or (vi) a minter of the NFT.

The insurance premium determiner 824 may determine the insurance premium(s) via any suitable technique. For example, the insurance premium determiner 824 may determine the insurance premium(s) by using a trained machine learning algorithm, as will be described further below. In some examples, the machine learning algorithm may be trained by the machine learning training application 828.

To determine the insurance premium and/or train the machine learning algorithm, as will be described further below, the insurance server 802 may receive data from any suitable source, such as the NFT database 890, other external database 895, the distributed ledger 830 (e.g., from node, such as 850 or 860), the data store 818, etc.

The NFT database 890, in some embodiments, may be a database that broadly stores any information of NFTs of the distributed ledger 830 (e.g., information of present NFTs, digital assets that NFTs represent ownership of and/or reference links to, historical information of NFTs, etc.). Additionally or alternatively, the NFT database 890 may store data of NFTs of distributed ledger(s) other than the distributed ledger 830 (e.g., information of present NFTs, digital assets that NFTs represent ownership of and/or reference links to, historical information of NFTs, etc.).

The other external database 895 may store any suitable information. In some examples, the other external database 895 stores imagery and/or audio data. In some such examples, the insurance premium determiner 824 determines the uniqueness rating of the digital asset based upon information held by the other external database 895.

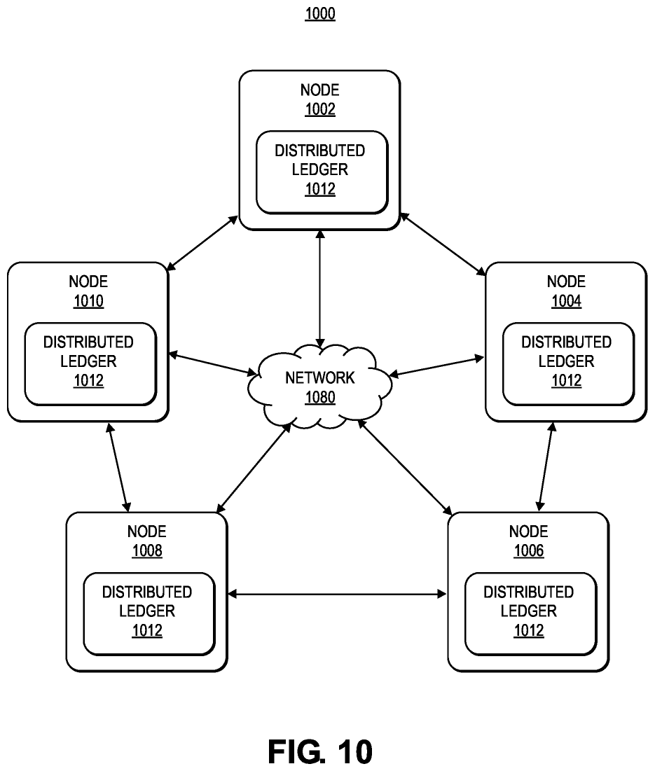

Furthermore, as will be further described elsewhere herein, the distributed ledger 830 (e.g., that holds the record of the NFT) may be maintained by a plurality of nodes, such as nodes 850, 860. According to embodiments, the network nodes 850, 860 may be a combination of hardware and software components, also as described in more detail below with reference to FIGS. 10-12 (e.g., the nodes 850, 860 correspond to the nodes of FIGS. 10-12). The network nodes 850, 860 may each include a memory 856, one or more processors 854, such as a microcontroller or a microprocessor, and other components not shown in FIG. 8 (e.g., a random-access memory (RAM), and/or an input/output (I/O) circuit), all of which may be interconnected via an address/data bus.

The memory 856 and/or RAM may store various applications for execution by the one or more processors 854. For example, a user interface application may provide a user interface to the network node 850, which user interface may, for example, allow the system administrator to configure, troubleshoot, and/or test various aspects of the node's operation.

The memory 856 may be tangible, non-transitory memory and may include any types of suitable memory modules, including RAM, read-only memory (ROM), flash memory, other types of persistent memory, etc. The memory 856 may store, for example, instructions executable on the processors 854 for a validator module 858.

The validator module 858 may validate changes to the blockchain (e.g., when a new transaction and/or block is created) according to a set of consensus rules. The consensus rules depend on the information being tracked by the blockchain and may include rules regarding the chain itself. For example, a consensus rule may include that the originator of a change supply a proof-of-identity such that only approved entities may originate changes to the chain. Consensus rules may include a mechanism to determine the order in which new blocks are added to the chain (e.g., through a proof-of-work system, proof-of-stake, etc.).

The validator module 858 may append distributed ledger data to the distributed ledger if the distributed ledger data satisfies the consensus rules by generating a new block of validated transactions to include in the distributed ledger 830 and/or by broadcasting a block of transactions to other network nodes. Otherwise, the validator module 858 may disregard any distributed ledger data that does not satisfy the consensus rules, and the distributed ledger data is not propagated to other network nodes. For example, the distributed ledger 830 may include NFTs that represent ownership of a digital asset and/or a physical asset.

The distributed ledger 830 may be accessed by user 870 through the user device 875 (e.g., a virtual reality (VR) headset, a computer, a tablet, a smartphone, an augmented reality (AR) headset, a server, etc.). In some embodiments, the user device 875 is itself a node of the distributed ledger 830.

In addition, further regarding the example system 800, the illustrated example components may be configured to communicate, e.g., via a network 804 (which may be a wired or wireless network, such as the internet), with any other component. Furthermore, although the example system 800 illustrates only one of each of the components, any number of the example components are contemplated (e.g., any number of users, user devices, nodes, insurance servers, databases, distributed ledgers, etc.).

### Exemplary Machine Learning Techniques

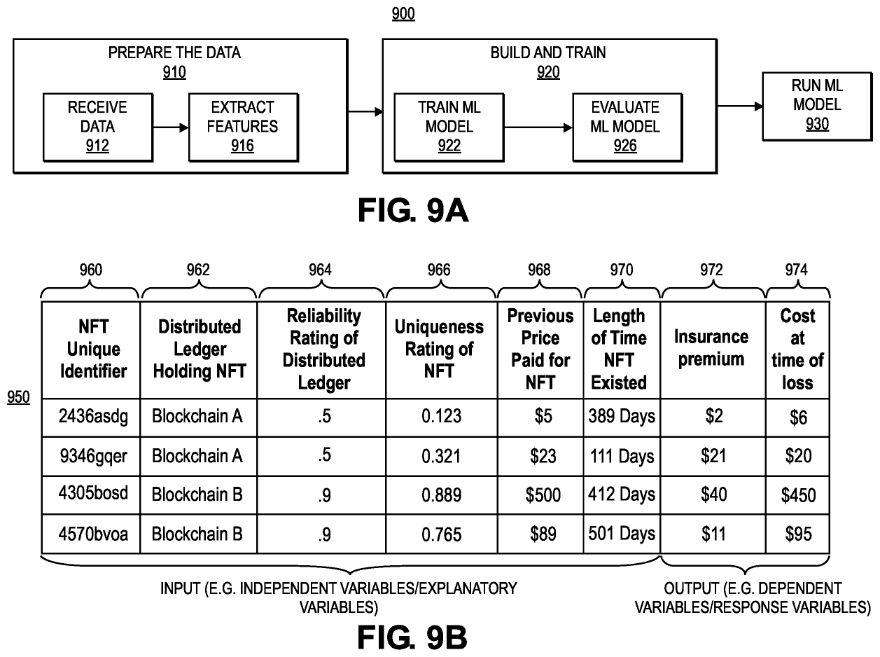

Broadly speaking, the machine learning training application 828 may train a machine learning algorithm to, for example, determine an insurance premium for the NFT. FIG. 9A is a block diagram of an exemplary machine learning modeling method 900 for training and evaluating a machine learning model (e.g., a machine learning algorithm), in accordance with various embodiments. In some embodiments, the model “learns” an algorithm capable of performing the desired function, such as determining an insurance premium for the NFT. It should be understood that the principles of FIG. 9A may apply to any machine learning algorithm discussed herein.

At a high level, the machine learning modeling method 900 includes a block 910 to prepare the data, a block 920 to build and train the model, and a block 930 to run the model.

Block 910 may include sub-blocks 912 and 916. At block 912, the machine learning training application 828 may receive the historical information to train the machine learning algorithm. The historical information may include any information of historical NFTs and/or historical distributed ledgers. Examples of the historical information include: (i) reliability ratings of historical distributed ledgers, (ii) uniqueness rating of historical digital assets associated with NFTs on the historical distributed ledgers, (iii) historical prices paid for lost NFTs of the historical NFTs, (iv) prices paid for other NFTs of the historical distributed ledgers, (v) lengths of time that the historical NFTs have existed, (vi) historical minters of the historical NFTs, (vii) insurance premiums of the historical NFTs, and/or (viii) costs of historical NFTs at times of losses.

In some embodiments, the machine learning algorithm may be trained using the above (i)-(vi) as inputs to the machine learning model (e.g., also referred to as independent variables, or explanatory variables), and the above (vii)-(viii) are used as the outputs of the machine learning model (e.g., also referred to as a dependent variables, or response variables). Put another way, each of the above (i)-(vi) may have an impact on (vii)-(viii), which the machine learning algorithm is trained to find.

In some scenarios, the historical data includes historical insurance premiums. In some such scenarios, the machine learning algorithm may be directly trained to predict insurance premiums using the historical insurance premiums.

However, in other scenarios, the historical insurance premiums may not be available (or there is not sufficient data available to train the machine learning algorithm). As such, in some embodiments, the machine learning algorithm may be trained to determine insurance premiums via the output of the costs of NFTs at time of losses. For example, the machine learning algorithm may be trained to predict the costs of the NFTs at the time of loss (e.g., based upon (i)-(vi), etc.); then, further techniques may use the predicted cost at the time of loss to determine the insurance premium. For instance, the predicted cost at the time of loss (e.g., the output of the machine learning algorithm), may be input into a second model that determines insurance premium from the cost at the time of loss and/or other factors, as will be explained further below. Such embodiments therefore present a technical solution to a technical problem; that is, such embodiments solve the technical problem of how to train a machine learning algorithm to determine insurance premiums when historical data of insurance premiums is scarce or not available at all.

In some embodiments, the historical information may be held in the form of a table, such as the example table 950 illustrated in the example of FIG. 9B. The illustrated example table 950 includes NFT unique identifier 960, an identification of the distributed ledger holding the NFT 962, reliability rating of the distributed ledger 964, uniqueness rating of the digital asset 966, previous price paid for the NFT 968, length of time that the NFT existed 970, insurance premium 972, and cost at time of loss 974. It should be appreciated that the data table 950 is one example data structure associated with the historical information. In other examples, the insurance server 802 may implement one or more alternate data structures that represent the historical information. Additionally, in some embodiments, the insurance server normalizes one or more of the input variables to, for example, a scale of 0 to 1. For instance, in the example of FIG. 9B, the reliability rating, and uniqueness rating have been normalized.

In some embodiments, training the machine learning algorithm based upon less information (e.g., three or less of the inputs (i)-(vi)) has a technical advantage. Namely, the insurance premium may be calculated faster because there is less data to consider.

In other embodiments, training the machine learning algorithm based upon more information (e.g., four or more of the inputs (i)-(vi)) has a technical advantage. Namely such embodiments may have the advantage that the determined insurance premium may be more accurate because it uses more data points in its determination.

Generally, the machine learning model is trained to identify how each of the input variables may influence the output variables. For example, the more unique an NFT is, the more expensive it may be to replace, thus resulting in the machine learning model outputting a higher insurance premium.

The reliability rating of the distributed ledger (e.g., Blockchain A, or Blockchain B in the example of FIG. 9B) may also influence the insurance premium output by the machine learning model. In some embodiments, the reliability rating of the distributed ledger is based on (i) past security breaches of the distributed ledger, (ii) crash data of the distributed ledger, and/or (iii) a length of time that the distributed ledger has existed. For instance, the longer a distributed ledger has existed, the more reliable it may be.

The uniqueness rating of the digital asset may also influence the insurance premium output by the machine learning model. In some examples, the uniqueness rating is based upon similarity between (1) a digital asset associated with the NFT, and (2) other digital assets associated with other NFTs. For instance, if the NFT represents ownership of an image, and there are other NFTs that represent ownership of the same or similar images, this may result in a lower uniqueness rating.

The previous price paid for the NFT may also influence the insurance premium output by the machine learning model. For example, the previous price may be the original price paid for the NFT, a most recent price paid for the NFT, an average of all previous prices paid, a weighted average of previous prices paid (e.g., with the weights based on a recentness in time, etc.), etc.

Prices paid for other NFTs (e.g., held on the same distributed ledger as the NFT, etc.) may also influence the insurance premium output by the machine learning model. Although the prices paid for other NFTs are not listed in a specific column in the example table 950, they may be derived from the example table 950. For example, for the NFT with the unique identifier 2436asdg, the other NFT on the same blockchain (Blockchain A) is the NFT with the unique identifier 9346Ner.

The length of time that the NFT existed may also influence the insurance premium. The length of time may be a length of time that the NFT existed at a time of loss of the NFT, a length of time the NFT existed when the NFT was replaced or sold, etc.

It should be appreciated that while the foregoing sets out some input factors to the machine learning model, in other embodiments, additional, alternate, or fewer factors are used. In some embodiments, an input to the machine learning model trained at block 920 may be the output of another machine learning model trained to produce a metric characterizing the NFT. For example, the more desirable an NFT is, the more others may be tempted to engage in fraudulent behavior to misappropriate the NFT from the owner. In this example, an output of machine learning model trained to produce a desirability metric may be an input to the machine learning model trained at block 920.

At block 916 the machine learning training application 828 may extract features from the received data, and put them into vector form. For example, the features may correspond to the values associated with the historical data used as input factors. Furthermore, at block 916, the received data may be assessed and cleaned, including handling missing data and handling outliers. For example, missing records, zero values (e.g., values that were not recorded), incomplete data sets (e.g., for scenarios when data collection was not completed), outliers, and inconclusive data may be removed.

Block 920 may include sub-blocks 922 and 926. At block 922, the machine learning (ML) model is trained (e.g. based upon the data received from block 910). In some embodiments where historical insurance premiums are included in the historical information, the ML model “learns” an algorithm capable of calculating or predicting the target feature values (e.g., determining an insurance premium for NFTs) given the predictor feature values. However, in other embodiments where historical insurance premiums are not available, the machine learning algorithm may learn to instead predict a cost at a time of loss and/or replacement of the NFT (and/or other values upon which an insurance premium is based). The predicted cost may then in turn be used to determine the insurance premium. In one such working example, the machine learning algorithm is trained by creating multiple regression models to predict the cost at a time of loss of the NFT, and then selecting the best regression model (e.g., the regression model with the least error, etc.). In these embodiments, the output of this first machine learning algorithm (e.g., the cost of the time of loss of the NFT) may then input into a second model (e.g., a second machine learning algorithm, a regression model, a lookup table, etc.) to determine the insurance premium. For example, the model may be a machine learning algorithm that has been trained to determine insurance premiums from costs of real world items at a time of loss and/or other inputs.

Additionally, the machine learning model may include multiple layers. For example, in a first layer, the machine learning model may be configured to segment groups of NFTs into individual NFTs, and/or to identify and/or label NFTs. For example, the first layer may identify a type of NFT (e.g., digital asset NFT, a physical asset NFT, etc.). In this example, the second layer may then be configured to analyze the NFT based upon the type (e.g., digital asset NFT analyzed based upon similarity to other digital asset NFTs, physical asset NFT analyzed based upon similarity to other physical asset NFTs, etc.). As another example, the reliability rating 964 and/or the uniqueness rating 966 may also be the outputs of a machine learning model trained to output the corresponding rating.

At block 926, the machine learning training application 828 evaluates the machine learning model, and determines whether or not the machine learning model is ready for deployment.

Further regarding block 926, evaluating the model sometimes involves testing the model using testing data or validating the model using validation data. Testing/validation data typically includes both predictor feature values and target feature values (e.g., including known inputs and outputs), enabling comparison of target feature values predicted by the model to the actual target feature values, enabling one to evaluate the performance of the model. This testing/validation process is valuable because the model, when implemented, will generate target feature values for future input data that may not be easily checked or validated.

Thus, it is advantageous to check one or more accuracy metrics of the model on data for which the target answer is already known (e.g., testing data or validation data, such as data including historical information associated with the NFTs), and use this assessment as a proxy for predictive accuracy on future data. Exemplary accuracy metrics include key performance indicators, comparisons between historical trends and predictions of results, cross-validation with subject matter experts, comparisons between predicted results and actual results, etc.

At block 930, the machine learning training application 828 runs the ML model. For example, information associated with an NFT may be routed to the trained machine learning algorithm to determine the insurance premium.

Exemplary Distributed Ledgers for Insured NFTs and/or Updating a Digital Inventory of Insured Items

FIG. 10 depicts an exemplary distributed ledger system 1000 for insuring NFTs and/or updating a digital inventory of insured items. The system 1000 may include a distributed ledger 1012 (e.g., having one or more distributed ledger layers) and a plurality of nodes 1002, 1004, 1006, 1008, and 1010 (e.g., each similar to node 850 and/or 860 of FIG. 8, etc.). Each node maintains a copy of the distributed ledger 1012. As changes are made to the distributed ledger 1012, each node receives the change via the network 1080 and updates its respective copy of the distributed ledger 1012. A consensus mechanism may be used by the nodes 1002-1010 in the distributed ledger system 1000 to decide whether it is appropriate to make received changes to the distributed ledger 1012 or to a particular layer of the distributed ledger 1012.

Each node in the system therefore has its own copy of the distributed ledger 1012, which is identical to every other copy of the distributed ledger 1012 stored by the other nodes. The distributed ledger system 1000 may be more robust than a central authority database system because of the distributed ledger's decentralized nature. As such, there is no single point of failure on the distributed ledger system 1000 as there would be in a centralized system.

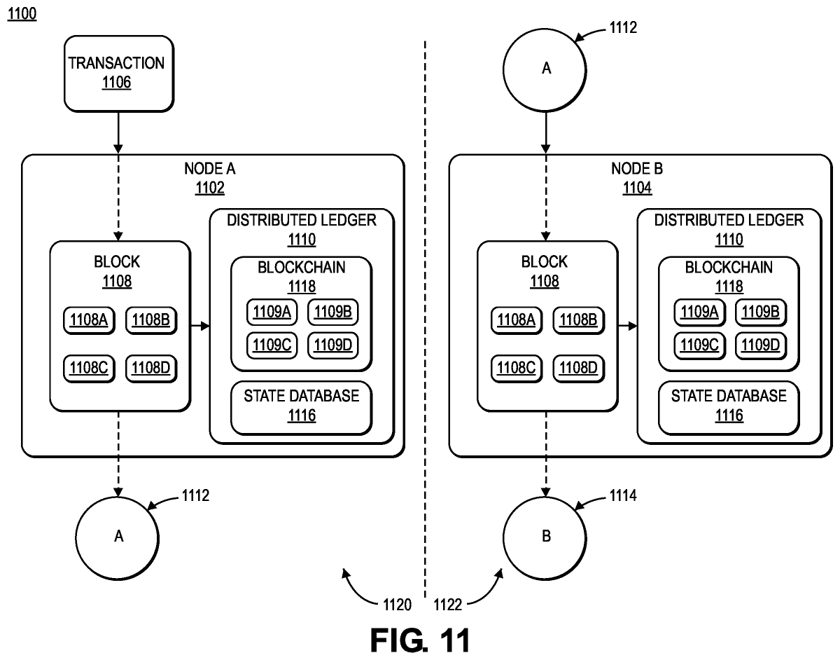

FIG. 11 depicts exemplary network nodes and an exemplary transaction flow 1100 on a distributed ledger network for insuring NFTs and/or updating a digital inventory of insured items. FIG. 11 includes two time frames 1120 and 1122 represented by the left and right sides of the dotted line, respectively, Node A 1102 (e.g., node 850) and Node B 1104 (e.g., node 860), a set of transactions 1108A-1108D, a set of blocks of transactions 1109A-1109D, a distributed ledger 1110, and a blockchain 1118.

The block propagation flow 1100 may begin with Node A 1102 receiving transaction 1106 at time 1120. When Node A 1102 confirms that transaction 1106 is valid, Node A 1102 may add the transaction to a newly generated block 1108. As part of adding the transaction 1106 to block 1108, Node A 1102 may solve a cryptographic puzzle and include the solution in the newly generated block 1108 as proof of the work done to generate the block 1108. Alternatively, a proof of stake algorithm may be used to generate the block 1108, whereby Node A 1102 “stakes” an amount of a digital token used on the network, however, the network itself determines the node that will mint the new block. In another implementation, a proof of authority (PoA) algorithm may be used to generate the block 1108, where transactions and blocks are validated by approved accounts, known as validators which run software allowing them to record transactions in the distributed ledger.

In other embodiments, the transaction 1106 may be added to a pool of transactions until a sufficient number of transactions in the pool exist to form a block or distributed ledger entry. Node A 1102 may transmit the newly created distributed ledger entry 1108 to the network at time 1112. Before or after propagating the distributed ledger entry 1108, Node A 1102 may add the distributed ledger entry 1108 to its copy of the blockchain 1118.

While proof of work, proof of stake, and proof of authority are described herein as consensus algorithms for selecting a node to mint a new block, these are merely a few example consensus algorithms and are not intended to be limiting. Additional consensus algorithms may be utilized, such as delegated proof of stake where nodes elect a subset of nodes referred to as delegates to perform validation, and the delegates take turns minting new blocks. Consensus algorithms may also include proof of weight, Byzantine fault tolerance, tangle consensus algorithms, block lattice consensus algorithms, etc. Additionally, quorum slices may be selected where a quorum is a set of nodes that participate in the consensus protocol and a quorum slice is its subset that helps a node in its agreement process. Individual trust decisions may be made by participants in the distributed ledger network to construct a quorum slice. Still further, security circles may be identified which are closed groups of network participants who together can form a quorum to reach a consensus on a transaction and to make further trust decisions.

In any event, the transactions 1109A-1109D may include updates to a state database 1116. The state database 1116 may contain current values of variables created by smart contracts deployed on the blockchain 1118. Validated distributed ledger entries, such as distributed ledger entry 1108, may include transactions effecting state variables in state database 1116. At time 1122, Node B 1104 may receive the newly created distributed ledger entry 1108 via the network at 1112. Node B 1104 may verify that the distributed ledger entry 1108 is valid by checking the solution to the cryptographic puzzle provided in the distributed ledger entry 1108. If the solution is accurate, then Node B 1104 may add the distributed ledger entry 1108 to its blockchain 1118 and make any updates to the state database 1116 as rejected by the transactions in distributed ledger entry 1108. Node B 1104 may then transmit the distributed ledger entry 1108 to the rest of the network at time 1114.

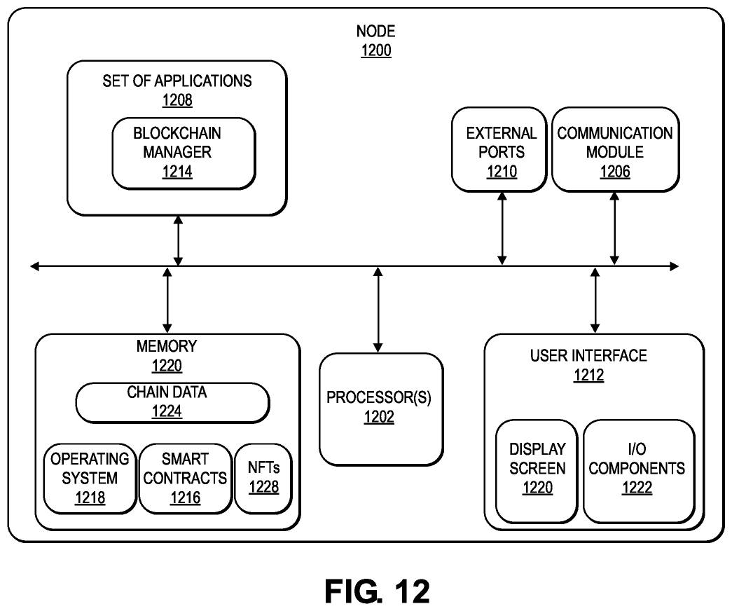

FIG. 12 depicts exemplary components of a network node 1200 on a distributed ledger network for insuring NFTs and/or updating a digital inventory of insured items. The network node 1200 may be similar to the network nodes 850, 860 described above with reference to FIG. 8. Network node 1200 may include at least one processor 1202, memory 1204, a communication module 1206 such as a transceiver, a set of applications 1208, external ports 1210, a blockchain manager 1214, smart contracts 1216, NFTs 1228, an operating system 1218, user interface 1212, display screen 1220, and/or I/O components 1222. In some embodiments, the network node 1200 may generate a new block of transactions, or may broadcast transactions to other network nodes via the communication module 1206 by using the blockchain manager 1214. Similarly, the network node 1200 may use the blockchain manager 1214 in conjunction with the NFTs 1228 and/or the smart contracts 1216 stored in the memory 1204 to provide the functionality disclosed herein. The memory 1204 may further include chain data 1224 including, for example, a state database of the blockchain for storing states of smart contracts deployed thereon.

In other embodiments, the smart contracts 1216 operate independent of the blockchain manager 1214 or other applications. In some embodiments, the network node 1200 does not have a blockchain manager 1214, NFTs 1228, or smart contracts 1216 stored at the network node. In some embodiments, the network node 1200 may have additional or fewer components than described.

### Exemplary Methods for Insurance of an NFT

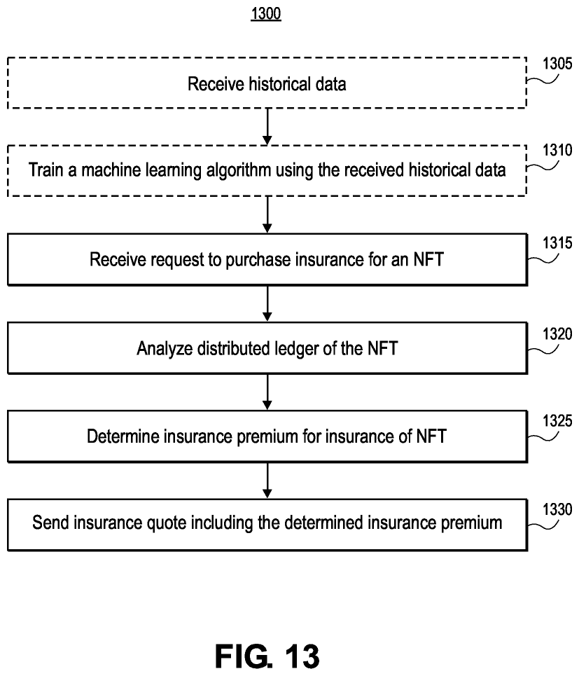

FIG. 13 shows an exemplary computer-implemented method or implementation 1300 of providing insurance for NFTs. The exemplary implementation 1300 may begin at optional block 1305 when the one or more processors 820 receive historical information of historical NFTs (e.g., from NFT database 890, data store 818, and/or a network node such as 850, 860). At block 1310, the machine learning algorithm may optionally be trained using the historical data. Blocks 1305 and 1310 may occur as described above (e.g., with respect to FIGS. 9A-9B).

At block 1315, the one or more processors 820 receive a request to purchase insurance for an NFT. The request may be for any kind of insurance. For example, the insurance may insure against a security breach of the distributed ledger, the distributed ledger becoming defunct, corruption of data corresponding to an asset (e.g., an image, video, and/or audio recording) that the NFT represents ownership of, and/or physical destruction of a database (e.g., NFT database 890, etc.) holding data corresponding to the asset that the NFT represents ownership of. In another example, the insurance may be insurance protecting against a third party infringing a copyright corresponding to an asset that the NFT represents ownership of.

NFT to determine at least insurability metric. Examples of insurability metrics include: (i) a reliability rating of the distributed ledger, (ii) a uniqueness rating of the digital asset, (iii) a historical price paid for the NFT, (iv) prices paid for other NFTs on the distributed ledger, (v) a length of time the NFT has existed, and/or (vi) a minter of the NFT. In some embodiments, this involves receiving information from a network node (e.g., 850 and/or 860, etc.), and analyzing and/or processing the received information.

Moreover, any of the above (i)-(vi) may be determined based upon any suitable criteria and/or in any suitable way. For example, the reliability rating may based upon: (a) past security breaches of the distributed ledger, (b) crash data of the distributed ledger, and/or (c) a length of time that the distributed ledger has existed.

In another example, (ii), the uniqueness rating, may be determined by comparing a digital asset associated with the NFT to other digital assets. For example, if the digital asset is an image, the image may be compared to other images. In some examples, the other digital assets that the digital asset is compared to may be other digital assets of other NFTs of the distributed ledger (e.g., stored in NFT database 890). Additionally or alternatively, the other digital assets that the digital asset is compared to may be digital assets that do not correspond to NFTs of the distributed ledger (e.g., digital assets stored in other external database 895). Such comparisons may be made by any suitable technique. For example, a similarity determining machine learning algorithm may be used to determine similarity between the digital assets. In another example, if the digital asset is an image, pixel values and/or other data of the images may be compared. In yet another example, the comparison includes comparing metadata of the compared imagery data and/or audio data. Specifically, the metadata may contain labels (e.g. applied to the NFT, etc.) that may be used in the comparison (e.g., the labels may be compared, etc.).

In another example, (vi), the minter of the NFT is the author of the NFT (e.g., the person who minted the NFT). Sometimes, but not always, the minter of the NFT is also the copyright owner of the digital asset that the NFT represents ownership of. In some examples, (vi) is determined based upon information of the minter, such as insurance claims that the minter has placed, if the minter has lost other NFTs, how many NFTs the minter has sold, how many NFTs the minter has minted, etc.

At block 1325, the one or more processors 820 determine the insurance premium. The determination may be made based upon any suitable criteria. In some examples the determination is made based upon the determined at least one insurability metric. In some examples where the insurance insures against a third party infringing a copyright corresponding to an asset that the NFT represents ownership of, the determination is made based upon at least one of (ii)-(vi) above. For instance, (i), the reliability rating of the distributed ledger of the NFT, may not be useful in determining insurance premiums for copyright infringement.

In some examples, the one or more processors 820 determine the insurance premium by using a machine learning algorithm (e.g., as discussed above with respect to FIGS. 9A and 9B).

At block 1330, the one or more processors 820 send an insurance quote including the determined insurance premium to the user computing device 875.

It should be understood that not all blocks and/or events of the exemplary signal diagrams and/or flowcharts are required to be performed. Moreover, the exemplary signal diagrams and/or flowcharts are not mutually exclusive (e.g., block(s)/events from each example signal diagram and/or flowchart may be performed in any other signal diagram and/or flowchart). The exemplary signal diagrams and/or flowcharts may include additional, less, or alternate functionality, including that discussed elsewhere herein.

### Additional Exemplary Embodiments for Providing Insurance of an NFT

In one aspect, a computer-implemented method for insurance of a non-fungible token (NFT) may be provided. The method may be implemented via one or more local or remote processors, servers, transceivers, sensors, memory units, storage devices, virtual reality headsets, smart glasses, augmented reality headsets or glasses, wearables, mobile devices, smart watches, smart devices, and/or other electronic or electric components. For instance, the method may include: (1) receiving, via one or more processors and from a computing device of a customer, a request to purchase insurance for the NFT; (2) analyzing, via the one or more processors, a distributed ledger associated with the NFT to determine at least one insurability metric, wherein the at least one insurability metric includes: (i) a reliability rating of the distributed ledger, (ii) a uniqueness rating of the digital asset, (iii) a historical price paid for the NFT, (iv) prices paid for other NFTs on the distributed ledger, (v) a length of time the NFT has existed, and/or (vi) a minter of the NFT; (3) determining, via the one or more processors, an insurance premium for the insurance of the NFT based upon the determined at least one insurability metric; and/or (4) sending, via the one or more processors, an insurance quote including the determined insurance premium to the computing device of the customer. The method may include additional, fewer, or alternate actions, including those discussed elsewhere herein.

In some embodiments, analyzing the distributed ledger of the NFT comprises: routing, via the one or more processors, information of the NFT to a machine learning algorithm that is (i) trained using a historical insurability metric, and/or (ii) configured to output data upon which the insurance premium determination is based.

In some embodiments, the historical information includes: (i) reliability ratings of historical distributed ledgers, (ii) uniqueness rating of historical digital assets associated with NFTs on the historical distributed ledgers, (iii) historical prices paid for lost NFTs of the historical NFTs, (iv) prices paid for other NFTs of the historical distributed ledgers, (v) lengths of time that the historical NFTs have existed, (vi) historical minters of the historical NFTs, (vii) insurance premiums of the historical NFTs, and/or (viii) costs of historical NFTs at times of losses.

In some embodiments, the insurance premium for the insurance of the NFT is based upon the reliability rating of the distributed ledger, and/or the reliability rating is based upon: (i) past security breaches of the distributed ledger, (ii) crash data of the distributed ledger, and/or (iii) a length of time that the distributed ledger has existed.

In some embodiments, the digital asset may include imagery data and/or audio data.

In some embodiments, the insurance premium for the insurance of the NFT is determined based upon the uniqueness rating of the digital asset; and/or analyzing the distributed ledger includes: determining, via the one or more processors, the uniqueness rating of the digital asset by comparing the imagery data and/or audio data to imagery data and/or audio data corresponding to other NFTs, wherein the imagery data and/or audio data includes metadata including labels.

In some embodiments, the other NFTs are maintained on the distributed ledger.

In some embodiments, sending the insurance quote includes sending, via the one or more processors, the insurance quote for an insurance product that insures against a third party infringing a copyright corresponding to the digital asset.

In some embodiments, sending the insurance quote may include: sending, via the one or more processors, the insurance quote for an insurance product that insures against at least one of (i) a security breach of the distributed ledger, (ii) the distributed ledger becoming defunct, (iii) corruption of data corresponding to of the digital asset, and/or (iv) physical destruction of a database at which the digital asset is maintained.

In another aspect, a computer system configured to provide insurance of a non-fungible token (NFT) of one or more virtual items in a virtual environment may be provided. The computer system may include via one or more local or remote processors, servers, transceivers, sensors, memory units, storage devices, virtual reality headsets, smart glasses, augmented reality headsets or glasses, wearables, mobile devices, smart watches, smart devices, and/or other electronic or electric components. For instance, the computer system may include one or more processors configured to: (1) receive, from a computing device of a customer, a request to purchase insurance for the NFT; (2) analyze a distributed ledger associated with the NFT to determine at least one insurability metric, wherein the at least one insurability metric includes: (i) a reliability rating of the distributed ledger, (ii) a uniqueness rating of the digital asset, (iii) a historical price paid for the NFT, (iv) prices paid for other NFTs on the distributed ledger, (v) a length of time the NFT has existed, and/or (vi) a minter of the NFT; (3) determine an insurance premium for the insurance of the NFT based upon the determined at least one insurability metric; and/or (4) send an insurance quote including the determined insurance premium to the computing device of the customer. The computer system may include additional, less, or alternate functionality, including that discussed elsewhere herein.

In some embodiments, the digital asset may include imagery data and/or audio data.

In some embodiments, the one or more processors are configured to analyze the distributed ledger of the NFT by: routing, via the one or more processors, information of the NFT to a machine learning algorithm that is (i) trained using historical information of historical NFTs, and (ii) configured to output data upon which the insurance premium determination is based.

In some embodiments, the one or more processors are further configured to: determine insurance premium for the insurance of the NFT based upon the reliability rating of the distributed ledger; and/or determine the reliability rating based upon: (i) past security breaches of the distributed ledger, (ii) crash data of the distributed ledger, and/or (iii) a length of time that the distributed ledger has existed.

In some embodiments, the NFT represents ownership of a digital asset comprising imagery data and/or audio data, and the one or more processors are further configured to: determine the insurance premium for the insurance of the NFT based upon the uniqueness rating of the digital asset; and/or determine the uniqueness rating of the digital asset by comparing the imagery data and/or audio data to imagery data and/or audio data corresponding to other NFTs of the distributed ledger.

In some embodiments, the one or more processors are configured to send the insurance quote by: sending the insurance quote for an insurance product that insures against at least one of (i) a security breach of the distributed ledger, (ii) the distributed ledger becoming defunct, (iii) corruption of data corresponding to of the digital asset, and/or (iv) physical destruction of a database at which the digital asset is maintained.

In yet another aspect, a computer device configured to provide insurance of a non-fungible token (NFT) may be provided. The computer device may include: one or more processors; and/or one or more memories coupled to the one or more processors. The one or more memories including computer executable instructions stored therein that, when executed by the one or more processors, cause the one or more processors to: (1) receive, from a computing device of a customer, a request to purchase insurance for the NFT; (2) analyze a distributed ledger associated with the NFT to determine at least one insurability metric, wherein the at least one insurability metric includes: (i) a reliability rating of the distributed ledger, (ii) a uniqueness rating of the digital asset, (iii) a historical price paid for the NFT, (iv) prices paid for other NFTs on the distributed ledger, (v) a length of time the NFT has existed, and/or (vi) a minter of the NFT; (3) determine an insurance premium for the insurance of the NFT based upon the determined at least one insurability metric; and/or (4) send an insurance quote including the determined insurance premium to the computing device of the customer. The computer device may include additional, less, or alternate functionality, including that discussed elsewhere herein.

In some embodiments, the digital asset may include imagery data and/or audio data.

In some embodiments, the one or more memories including computer executable instructions stored therein that, when executed by the one or more processors, further cause the one or more processors to analyze the distributed ledger of the NFT by: routing, via the one or more processors, information of the NFT to a machine learning algorithm that is (i) trained using historical information of historical NFTs, and/or (ii) configured to output data upon which the insurance premium determination is based.

In some embodiments, the one or more memories including computer executable instructions stored therein that, when executed by the one or more processors, further cause the one or more processors to: determine insurance premium for the insurance of the NFT based upon the reliability rating of the distributed ledger; and/or determine the reliability rating based upon: (i) past security breaches of the distributed ledger, (ii) crash data of the distributed ledger, and/or (iii) a length of time that the distributed ledger has existed.

In some embodiments, the one or more memories including computer executable instructions stored therein that, when executed by the one or more processors, further cause the one or more processors to send the insurance quote by: sending the insurance quote for an insurance product that insures against at least one of (i) a security breach of the distributed ledger, (ii) the distributed ledger becoming defunct, (iii) corruption of data corresponding to of the digital asset, and/or (iv) physical destruction of a database at which the digital asset is maintained.

### Exemplary System for Updating an Inventory of Insured Items

Broadly speaking, many insurance policies (e.g., homeowners, and renters insurance policies) cover a wide range of items in the event of a loss. For example, if a home is lost, a homeowners insurance policy may cover electronics, furniture, etc. that were lost along with the home. As such, it is useful for an insurance customer to keep an updated inventory list of insured items. To this end, the techniques described herein may provide such an inventory via a digital wallet of non-fungible tokens (NFTs) configured to store NFTs that correspond to insured items associated with the insurance customer.

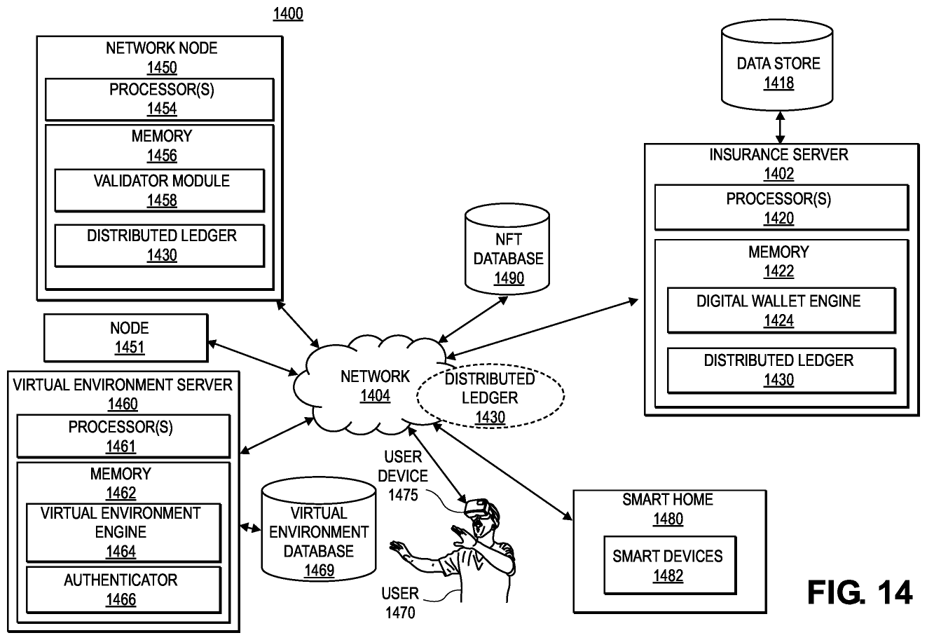

FIG. 14 shows an exemplary computer system 1400 for updating an inventory of insured items in which the exemplary computer-implemented methods described herein may be implemented. The high-level architecture includes both hardware and software applications, as well as various data communications channels for communicating data between the various hardware and software components. Broadly, the digital wallet of NFTs may be created by the insurance server 1402. In some embodiments, the insurance server 1402 is also a node on the distributed ledger 1430.

The insurance server 1402 may include one or more processors 1420 such as one or more microprocessors, controllers, and/or any other suitable type of processor. The insurance server 1402 may further include a memory 1422 (e.g., volatile memory, non-volatile memory) accessible by the one or more processors 1420, (e.g., via a memory controller). The one or more processors 1420 may interact with the memory 1422 to obtain and execute, for example, computer-readable instructions stored in the memory 1422. Additionally or alternatively, computer-readable instructions may be stored on one or more removable media (e.g., a compact disc, a digital versatile disc, removable flash memory, etc.) that may be coupled to the insurance server 1402 to provide access to the computer-readable instructions stored thereon. In particular, the computer-readable instructions stored on the memory 1422 may include instructions for executing various applications, such as digital wallet engine 1424.

An insurance company that operates the insurance server 1402 may provide insurance to the user 1470. For instance, the insurance company may provide insurance to the user 1470 for a homeowners or renters insurance policy. In other examples, the insurance company provides insurance to the user 1470 directly for individual items, such as a vehicle, an electronics item (e.g., a television (TV), etc.), or other valuable item (e.g., a violin, a piano, etc.), etc.

Furthermore, as mentioned above, many insurance policies, such as homeowners and renters insurance policies, cover a wide range of items in the event of a loss (e.g., if a home is lost, a homeowners insurance policy may cover electronics, furniture, etc. that were lost along with the home). As such, it is useful for the user 1470 (e.g., the insurance customer) to keep an updated inventory list of insured items. To this end, some techniques described herein leverage that potential ownership of items may be identified by NFTs (e.g., NFTs recorded on a distributed ledger, such as distributed ledger 1430).

For example, the user 1470 may own an NFT, which may be a record on the distributed ledger 1430. The NFT may indicate ownership of a digital asset or physical asset. If the asset is a digital asset, the NFT may also contain a reference to a link to a storage location that stores the digital asset, such as a storage location in NFT database 1490 (e.g., the NFT database 1490 stores imagery and/or audio data of the digital asset). In another example, digital assets may be virtual items (e.g., items in a virtual environment, as will be further described below). In some such examples, the NFT references a link to a model of the virtual item stored by the virtual environment server 1460. Additionally or alternatively, in certain scenarios, if the asset is a physical asset, the NFT may also contain a reference to a link to a storage location, such as a storage location in NFT database 1490 (e.g., the physical asset is real estate, and the NFT database 1490 stores the property deed).

In operation, and as will be further described elsewhere herein, the digital wallet engine 1424 may create, update, and present a digital wallet of NFTs that correspond to insured items associated with an individual (e.g., the user 1470). Broadly speaking, this may involve analyzing information from distributed ledgers, such as distributed ledger 1430, to determine NFTs corresponding to insured items owned by the user 1470. Additionally or alternately, the digital wallet engine 1424 may determine NFTs to add to the digital wallet via information from any other source, such as from the smart home 1480, the data store 1418, the virtual environment server 1460, etc.

Furthermore, as described elsewhere herein, the distributed ledger 1430 (e.g., that holds the record of the NFT) may be maintained by a plurality of nodes, such as nodes 1450, 1451. According to embodiments, the network nodes 1450, 1451 may be a combination of hardware and software components, also as described in more detail with reference to FIGS. 10-12 (e.g., the nodes 1450, 1451 correspond to the nodes of FIGS. 10-12). The network nodes 1450, 1451 may each include a memory 1456, one or more processors 1454, such as a microcontroller or a microprocessor, and other components not shown in FIG. 14 (e.g., a random-access memory (RAM), and/or an input/output (I/O) circuit), all of which may be interconnected via an address/data bus.

The memory 1456 and/or RAM may store various applications for execution by the one or more processors 1454. For example, a user interface application may provide a user interface to the network node 1450, which user interface may, for example, allow the system administrator to configure, troubleshoot, and/or test various aspects of the node's operation.

The memory 1456 may be tangible, non-transitory memory and may include any types of suitable memory modules, including RAM, read-only memory (ROM), flash memory, other types of persistent memory, etc. The memory 1456 may store, for example, instructions executable on the processors 1454 for a validator module 1458.

The validator module 1458 may validate changes to the blockchain (e.g., when a new transaction and/or block is created) according to a set of consensus rules. The consensus rules depend on the information being tracked by the blockchain and may include rules regarding the chain itself. For example, a consensus rule may include that the originator of a change supply a proof-of-identity such that only approved entities may originate changes to the chain. Consensus rules may include a mechanism to determine the order in which new blocks are added to the chain (e.g., through a proof-of-work system, proof-of-stake, etc.).

The validator module 1458 may append distributed ledger data to the distributed ledger if the distributed ledger data satisfies the consensus rules by generating a new block of validated transactions to include in the distributed ledger 1430 and/or by broadcasting a block of transactions to other network nodes. Otherwise, the validator module 1458 may disregard any distributed ledger data that does not satisfy the consensus rules, and the distributed ledger data is not propagated to other network nodes. For example, the distributed ledger 1430 may include NFTs that represent ownership of a digital asset and/or a physical asset. In some examples, the distributed ledger 1430 also holds insurance information of the asset (e.g., an identification of a policy holder, insurance premium information, insurance policy terms, coverage amounts, etc.).

In some examples, the distributed ledger 1430 may be accessed by user 1470 through the user device 1475 (e.g., a virtual reality (VR) headset, a computer, a tablet, a smartphone, an augmented reality (AR) headset, a server, etc.). In some embodiments, the user device 1475 is itself a node of the distributed ledger 1430.

In some examples, the distributed ledger 1430 is a supply chain distributed ledger. For example, the distributed ledger tracks possession and/or ownership of physical items. In some examples, the digital wallet engine 1424 uses data from the supply chain distributed ledger 1430 to determine that the user 1470 now possesses or owns the physical item.

Additionally or alternatively, the distributed ledger 1430 may be a virtual item distributed ledger. For example, the distributed ledger 1430 may hold information of virtual items of a virtual environment (e.g., a virtual environment provided by the virtual environment server 1460).

Additionally or alternatively, the distributed ledger 1430 may be a vender distributed ledger. For example, the distributed ledger 1430 may hold information of items sold by venders (e.g., a distributed ledger that records when the vender sells an item, such as to the user 1470).

In this regard, although the example computer system 1400 illustrates only one distributed ledger 1430, any number of distributed ledgers may be used. For example, there may be a supply chain distributed ledger, a virtual item distributed ledger, and/or a vender distributed ledger.

The NFT database 1490, in some embodiments, may be a database that broadly stores any information of NFTs of the distributed ledger 1430 (e.g., information of present NFTs, digital assets that NFTs represent ownership of and/or reference links to, historical information of NFTs, etc.). Additionally or alternatively, the NFT database 1490 may store data of NFTs of distributed ledger(s) other than the distributed ledger 1430 (e.g., information of present NFTs, digital assets that NFTs represent ownership of and/or reference links to, historical information of NFTs, etc.).

The digital wallet engine 1424 may also determine NFTs to include in the digital wallet from data received from the smart home 1480 and/or smart home devices 1482. For example, smart home devices 1482 may have corresponding NFTs, which may be added to the digital wallet.

The virtual environment server 1460, broadly speaking, may provide a virtual environment, such as a metaverse. The virtual environment may allow user-controlled characters (e.g., as represented by avatars in the virtual environment) to traverse the virtual world, interact with each other, gain experience, make purchases for real or virtual items, etc. As referred to herein, purchases refer to purchases made in traditional currency (e.g., U.S. dollars, Euros, etc.), cryptocurrency (e.g., Bitcoin, etc.), virtual currency (e.g., a currency used solely in the virtual world), and/or in exchange for other real or virtual items.

The virtual environment server 1460 may include one or more processors 1461 such as one or more microprocessors, controllers, and/or any other suitable type of processor. The virtual environment server 1460 may further include a memory 1462 (e.g., volatile memory, non-volatile memory) accessible by the one or more processors 1461, (e.g., via a memory controller). The one or more processors 1461 may interact with the memory 1462 to obtain and execute, for example, computer-readable instructions stored in the memory 1462. Additionally or alternatively, computer-readable instructions may be stored on one or more removable media (e.g., a compact disc, a digital versatile disc, removable flash memory, etc.) that may be coupled to the virtual environment server 1460 to provide access to the computer-readable instructions stored thereon. In particular, the computer-readable instructions stored on the memory 1462 may include instructions for executing various applications, such as virtual environment engine 1464, and/or an authenticator 1466.

In operation, the virtual environment engine 1464 may provide the virtual environment. For example, as described elsewhere herein, the virtual environment engine 1464 may provide the virtual environment to users such that characters may travel through the virtual environment, interact with each other, gain experience, make purchases, etc.

For instance, a user 1470 may wish to participate in the virtual environment. To do so, the user 1470 may use a user device 1475 (e.g., a virtual reality (VR) headset, smart glasses, wearables, smart watches, a computer, a tablet, a smartphone, an augmented reality (AR) headset, a server, etc.) to access the virtual environment. In this way, the user 1470 may create a character to interact with the virtual environment.

The virtual environment engine 1464 may store information of the character in the memory 1462 and/or the virtual environment database 1469. Furthermore, the memory 1462 and/or the virtual environment database 1469 may store any information related to the virtual environment. For example, the memory 1462 and/or the virtual environment database 1469, may store information of: characters, buildings, objects (e.g., vehicles, items of the characters, such as tools, weapons, etc.), businesses (e.g., insurance business, such as an insurance business that owns insurance server 1402), etc.

To access the virtual environment, in some examples, the user 1470 must be authenticated. To this end, the authenticator 1466 may authenticate the user 1470. For example, the user 1470 may be authenticated based upon authentication credentials, such as biometric data received from the user device 1475 (e.g., a VR headset automatically gathers biometric data and sends it as part of the authentication process).

Additionally or alternatively to authenticating the user 1470, the authenticator 1466 may authenticate the insurance server 1402. Once authenticated, in some embodiments, the insurance server 1402 may be permitted by the virtual environment server 1460 to provide insurance services to users of the virtual environment (e.g., user 1470). For example, the insurance server 1402 may create a digital wallet of NFTs (e.g., including NFTs corresponding to virtual items of the virtual environment provided by the virtual environment server 1460) and/or provide insurance to the user 1470 for one or more virtual items.

In addition, further regarding the example system 1400, the illustrated example components may be configured to communicate, e.g., via a network 1404 (which may be a wired or wireless network, such as the Internet), with any other component. Furthermore, although the example system 1400 illustrates only one of each of the components, any number of the example components are contemplated (e.g., any number of users, user devices, nodes, insurance servers, databases, distributed ledgers, etc.).

### Exemplary Methods for Updating an Inventory of Insured Items

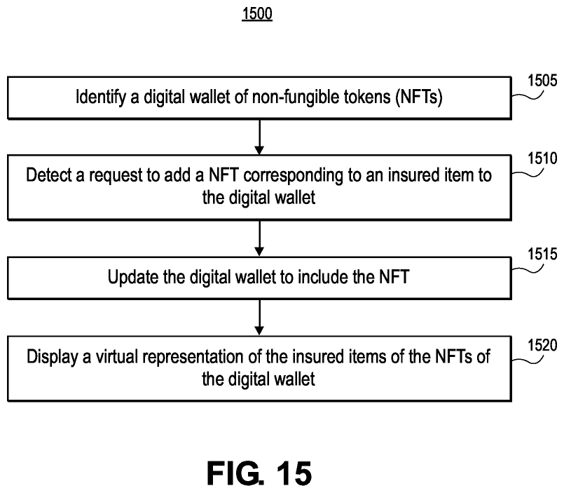

FIG. 15 shows an exemplary computer-implemented method or implementation 1500 of updating an inventory of insured items. The exemplary implementation 1500 may begin at block 1505 when the one or more processors 1420 identify a wallet of NFTs. The wallet may be identified from information from any suitable source, such as the data store 1418 (e.g., in embodiments where the digital wallet is stored in the data store 1418), the user device 1475, the smart home 1480 (e.g., from a hub of the smart home 1480), the NFT database 1490, etc.

Furthermore, the digital wallet may identify insurance policies corresponding to the insured items. For example, the digital wallet may identify a homeowners and/or renters insurance policy. The homeowners and/or renters insurance policy may specify that certain types of items (e.g., electronics, furniture, kitchen appliances, etc.) are covered under the policy. The digital wallet may thus includes those types of items. Additionally or alternatively, the identified insurance policy or policies may be insurance policies for individual items (e.g., an insurance policy for a vehicle, an insurance policy for a TV, an insurance policy for a virtual item, etc.).

At block 1510, the one or more processors 1420 detect a request to add a NFT corresponding to an insured item to the digital wallet. In some embodiments, the request is received from the user device 1475. For example, the user 1470 may indicate through the user device 1475 that she would like to add a NFT to the digital wallet. Additionally or alternatively, the request may be automatically generated (e.g., the user device 1475 detects that a new item with insurance has been purchased, and automatically requests that an NFT corresponding to the new item be minted and added to the digital wallet).

Additionally or alternatively, the request may be received from the distributed ledger 1430. For example, the distributed ledger 1430 may automatically send a request that an item be added upon detection that an item has changed ownership (e.g., to the user 1470), and/or been delivered (e.g., again to the user 1470).

At block 1515, the one or more processors 1420, update the digital wallet to include the NFT. For example, if the digital wallet is stored in the data store 1418, the information of the digital wallet may be updated in the data store 1418 to include the NFT.

In some embodiments, the update to the digital wallet triggers a smart contract associated with the digital wallet to update an insurance policy based upon the updated digital wallet. In some examples, the updating of the insurance policy includes updating a list of insured items covered by the insurance policy based upon the updated digital wallet. Additionally or alternatively, the updating of the insurance policy includes updating an insurance premium based upon the updated digital wallet.

In some examples, the NFT added to the digital wallet may correspond to a TV, and the user 1470 may have a homeowners insurance policy that covers the TV (in, e.g., the event of the loss of the house, etc.). In some such examples, when the smart contract is triggered (e.g., by the updating of the digital wallet, etc.), the smart contract: (i) matches the TV to the homeowners insurance policy (e.g., based upon the type of the item, and types of items covered by the homeowners insurance policy), (ii) adds the TV to a list of insured items covered by the homeowners insurance policy, and/or (iii) recalculates the insurance premium for the homeowners insurance policy. It should be understood that these examples also apply to renters insurance policy.

In other examples, the insured item may be a virtual insured item. In some such examples, the user 1470 may have an insurance policy that broadly covers certain virtual items (e.g., all characters owned by the user 1470 in a particular virtual environment). In some such examples, when the smart contract is triggered (e.g., by the updating of the digital wallet, etc.), the smart contract: (i) matches the virtual item to an insurance policy (e.g., based upon the item being a virtual item, a type of the virtual item, the terms of the insurance policy, etc.), (ii) adds the virtual item to a list of insured items covered by the insurance policy, and/or (iii) recalculates the insurance premium for the insurance policy.

In some examples, the insured item also has a warranty. As such, in some examples the NFT may include the warranty (e.g., the warranty or information thereof is stored in the NFT, or the NFT includes a link that references a storage location, such as in the NFT database 1490, that includes the warranty or information thereof). In this regard, when the insurance policy is updated (e.g., by the smart contract at block 1515), the update to the insurance policy may include updating the insurance policy (or updating the list of items covered by the insurance policy) to include the warranty or warranty information.

At block 1520, the one or more processors 1420, display a virtual representation of the insured items of the NFTs of the digital wallet. The presentation may be made on, for example, a display of the user device 1475 (e.g., the one or more processors 1420 present the digital wallet to the user by sending instructions to the user device 1475).

The display to the user 1470 may be made in any suitable form. For example, the display may or may not be made via a virtual environment (e.g., a virtual environment provided by the virtual environment server 1460).

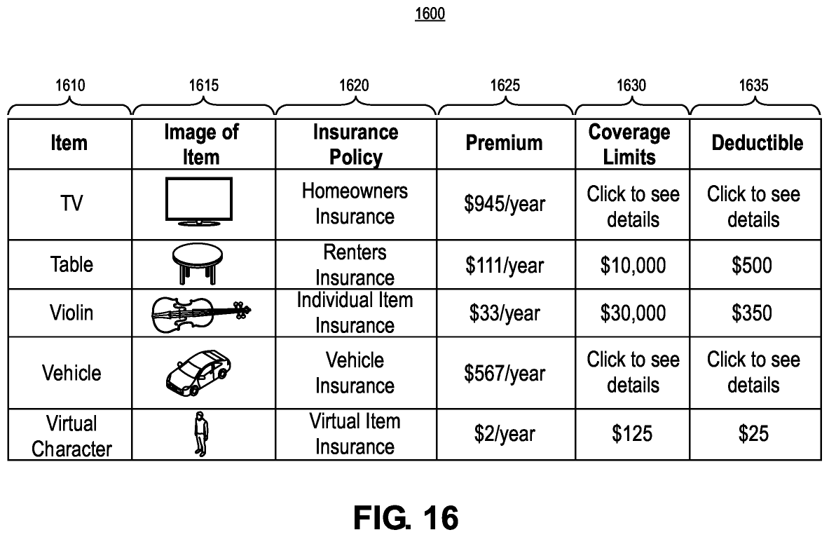

In some examples where the display is not made via a virtual environment, the display may be a list, as in the exemplary display 1600 of FIG. 16. With reference thereto, the exemplary display 1600 includes columns for a listing of the item 1610, an image of the item 1615, an insurance policy of the item 1620, an insurance premium 1625, coverage limits 1630, and/or deductibles 1635. In some examples, rather than directly list numbers, the display 1600 includes links to details. For example, for coverage limits for a vehicle insurance policy, a link to details may show coverage limits for the cost of the vehicle, coverage limits for property damage to another party, etc.

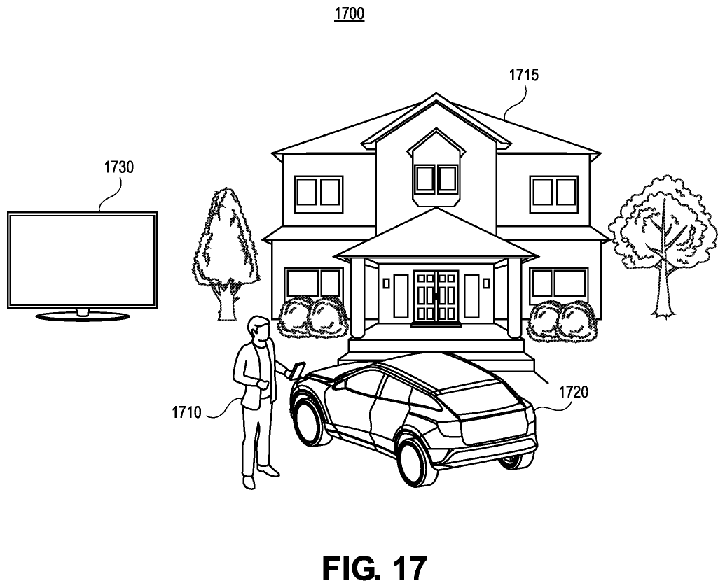

In other examples, the display may be made via a virtual environment (e.g., provided by the virtual environment server 1460), as in the exemplary environment 1700 of FIG. 17. With reference thereto, the exemplary environment 1700 includes virtual character 1710, a virtual house 1715, a representation of a physical vehicle 1720, and a representation of a physical TV 1730. The items displayed in the virtual environment 1700 may be representations of physical items or representations of virtual items. For instance, the character 1710 may be a virtual character for which the user 1470 owns an insurance policy. On the other hand, the vehicle 1720 may be a representation of a physical vehicle for which the user 1470 owns an insurance policy. Although not shown in the example of FIG. 17, displays in the virtual environment may also optionally include insurance policy, insurance premiums, coverage limits, and deductibles corresponding to the items.

In some embodiments, the user 1470 may select to view the digital wallet via the virtual environment, or view the digital wallet outside of the virtual environment. In some embodiments, the user 1470 may select to view only virtual items via the virtual environment, or only physical items via the virtual environment. In other embodiments, the user may select to view the digital wallet outside of the virtual environment, and further select to view only the virtual items or physical items outside of the virtual environment.

In some embodiments, to display a representation of a physical item in the virtual environment, a model of the physical item may need to be created. The model may be created by any suitable component, such as the insurance server 1402, the virtual environment server 1460, etc. The model may be created based upon any suitable data, such as imagery data of the item, color data of the item, dimensional data of the item, etc. As creating the model of the physical item may be computationally intensive, from a technical perspective it may be advantageous to create the model at the insurance server 1402 (rather than the virtual environment server 1460) because the virtual environment server 1460 may already be spending large amounts of resources to create and/or run the virtual environment.

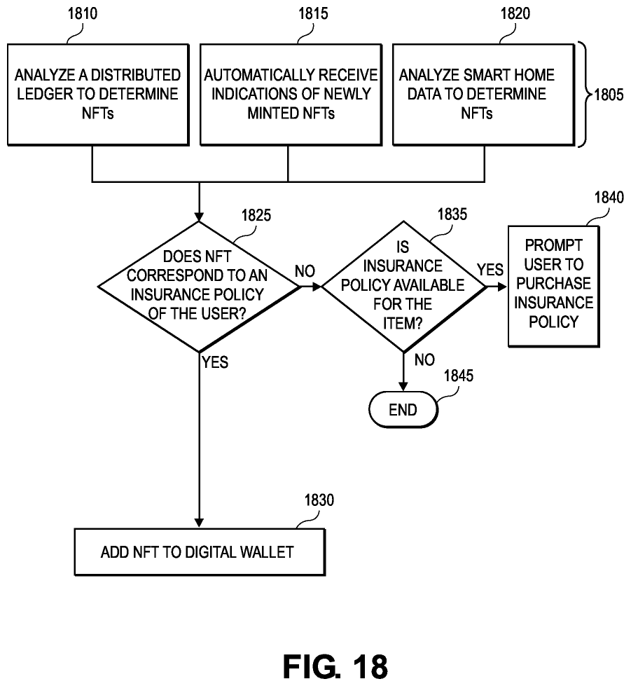

FIG. 18 shows an exemplary computer-implemented method or implementation 1800 of updating an inventory of insured items, including a phase of gathering NFTs that correspond to insured items associated with an individual. In some embodiments, the method or implementation 1800 is performed subsequently to the computer-implemented method or implementation 1500 (e.g., to further update and/or bring items into the digital wallet). In other embodiments, the method or implementation 1800 is performed prior to the computer-implemented method or implementation 1500 (e.g., to build initial items into the digital wallet). In still other examples, the methods or implementations 1500 and 1800 are combined. If the computer-implemented methods or implementations 1500 and 1800 are combined, the actions associated with the component blocks may be performed in any suitable order.

The exemplary implementation 1800 may include a phase 1805 to gather NFTs that correspond to items associated with an individual. For example, the one or more processors 1420 may gather information from: an analysis of a distributed ledger (block 1810), an automatic indication of a newly minted NFT (block 1815), and/or an analysis of smart home data (block 1820).

At block 1810, the one or more processors 1420 may analyze a distributed ledger 1430 to determine NFTs to potentially add to the digital wallet. In some examples, the insurance server 1402 searches the distributed ledger 1430 for NFTs to potentially add to the digital wallet.

For example, a search may identify NFTs that correspond to items associated with an individual. The NFTs may be identified based upon any suitable criteria, such as name of the individual, birthday of the individual, other identifying information, etc. In some examples, the insurance server 1402 may search for any item owned by the user 1470.

In some embodiments, the analysis also may also indicate if the item has a corresponding insurance policy (e.g., the distributed ledger 1430 includes information of insurance policies). In certain scenarios, the analysis also produces the details of the insurance policies, such as the premium, the coverage limit, the deductible, etc. For example, an insurance policy found on the distributed ledger 1430 may be matched (e.g., via an insurance policy number, etc.) to an insurance policy stored in the data store 1418, which has the details of the insurance policy.

In this regard, in some examples, the distributed ledger 1430 may be a supply chain distributed ledger (e.g., a distributed ledger that tracks possession and/or ownership of physical items). Additionally or alternatively, the distributed ledger 1430 may be a virtual item distributed ledger. For example, the distributed ledger 1430 may hold information of virtual items of a virtual environment (e.g., a virtual environment provided by the virtual environment server 1460).

In some examples, as part of or subsequent to the analysis, a node (e.g., 1450, 1451) may automatically send an indication to the one or more processors 1420 that a physical item has been delivered to the user 1470 (e.g., the distributed ledger 1430 is a supply chain distributed ledger).

At block 1815, the one or more processors 1420 may receive an indication of a newly minted NFT. For example, the distributed ledger 1430 may be a vender associated with the distributed ledger that newly mints a NFT when a physical item is sold to customers, such as the user 1470. In this example, the insurance server 1402 may receive an automatic indication from the distributed ledger when the NFT is minted.

At block 1820, the one or more processors 1420 analyze smart home data (e.g., from the smart devices 1482 and/or the smart home 1480 (e.g., from a hub of the smart home 1480) to determine NFTs corresponding to the user 1470. The NFTs may be identified by any suitable criteria, such as name of the individual, birthday of the individual, address of the individual, other identifying information, etc. In some embodiments, the information from the smart home 1480 and/or smart devices 1482 indicates if the items that correspond to the NFTs are insured.

At block 1825, the one or more processors 1420 determine if the items that correspond to the NFTs correspond to insurance policies of the user 1470 (e.g., if such insurance information was not gathered at 1805). In some examples, this may be directly determined from an identification of the item, or any other suitable criteria. For example, if the NFT corresponds to a vehicle, the one or more processors 1420 may match the vehicle (e.g., using the vehicle identification number (VIN), license plate number, or any other suitable criteria) with data of an insurance policy stored in the data store 1418 to determine that the user 1470 has an insurance policy for the vehicle.

In other examples, the one or more processors 1420 determine if the item is insured by determining if the item is broadly covered by an insurance policy, such as a homeowners insurance policy, or a renters insurance policy. If so, at block 1830, the item (e.g., the NFT corresponding to the item) may be added to the digital wallet. However, in some embodiments, prior to adding the item the item to the digital wallet, the user 1470 is presented with a representation of the item(s), and asked to make a selection of items to add to the digital wallet, thereby allowing the user to audit what is added to the digital wallet. This is useful in certain situations. For example, a vender distributed ledger may indicate that a TV was previously sold to the user 1470, but the TV is no longer in the user's 1470 possession (e.g., the user 1470 sold the TV), and thus the TV should not be added to the digital wallet.

If the answer at block 1825 is no, at block 1835 the one or more processors 1420 determine if an insurance policy is offered for the item. For example, if the item is a TV, the one or more processors 1420 may determine if an insurance policy is available for the TV; and, if so, also determine an insurance premium for the item.

If a policy is available for the item, the one or more processors 1420 may prompt, at block 1840, the user 1470 to purchase insurance for the item. The prompt may also include an insurance quote including the determined insurance premium.

If no policy is available for the item, the example method and/or implementation may end at 1845.

It should be understood that not all blocks and/or events of the exemplary signal diagrams and/or flowcharts are required to be performed. Moreover, the exemplary signal diagrams and/or flowcharts are not mutually exclusive (e.g., block(s)/events from each example signal diagram and/or flowchart may be performed in any other signal diagram and/or flowchart). The exemplary signal diagrams and/or flowcharts may include additional, less, or alternate functionality, including that discussed elsewhere herein.

### Additional Exemplary Embodiments for Updating an Inventory of Insured Items

In one aspect, a computer-implemented method for updating an inventory of insured items may be provided. The method may be implemented via one or more local or remote processors, servers, transceivers, sensors, memory units, storage devices, virtual reality headsets, smart glasses, augmented reality headsets or glasses, wearables, mobile devices, smart watches, smart devices, and/or other electronic or electric components. For instance, the method may include: (1) identifying, via one or more processors, a digital wallet of non-fungible tokens (NFTs) configured to store NFTs that correspond to insured items associated with an individual; (2) detecting, via the one or more processors, a request to add a NFT corresponding to an insured item to the digital wallet; and/or (3) updating, via the one or more processors, the digital wallet to include the NFT, wherein the update to the digital wallet triggers a smart contract associated with the digital wallet to update an insurance policy based upon the updated digital wallet. The method may include additional, fewer, or alternate actions, including those discussed elsewhere herein.

In some embodiments, the update to the insurance policy includes an update to a list of insured items covered by the insurance policy based upon the updated digital wallet.

In some embodiments, the computer-implemented method further includes: generating, via the one or more processors, the smart contract, wherein the smart contract is configured to: (i) determine, based upon a type of the insured item, an insurance policy that the insured item corresponds to, and/or (ii) add the insured item to the list of insured items of the insurance policy.

In some embodiments, the update to the insurance policy includes an update to an insurance premium of the insurance policy based upon the updated digital wallet.

In some embodiments, the computer-implemented method further may include: generating, via the one or more processors, the smart contract, wherein the smart contract is configured to trigger upon detecting an indication that the digital wallet has been updated.

In some embodiments, the computer-implemented method further may include: analyzing, via the one or more processors, a distributed ledger to determine NFTs corresponding to additional insured items associated with the individual; presenting, via the one or more processors, representations of the additional insured items to the individual; receiving, via the one or more processors and from a user device associated with the individual, a selection of one or more of the additional insured items associated with the individual to be added to the digital wallet; and/or adding, via the one or more processors, the selected one or more additional insured items to the digital wallet.

In some embodiments, the computer-implemented method further may include: receiving, via the one or more processors, smart home data from one or more smart home devices associated with the individual; analyzing, via the one or more processors, the smart home data to identify items that correspond to an NFT associated with insurance coverage; and/or adding the identified items to the digital wallet.

In some embodiments, the computer-implemented method further may include: automatically receiving, via the one or more processors, an indication that an NFT has been newly minted; determining, via the one or more processors, that the newly minted NFT corresponds to an insured item; determining, via the one or more processors, that the insured item is associated with the individual; and/or in response to the determinations that the newly minted NFT corresponds to the insured item, and that the insured item is associated with the individual, adding, via the one or more processors the item to the digital wallet.

In some embodiments, the computer-implemented method further may include: automatically receiving, via the one or more processors, an indication that an NFT has been newly minted; determining, via the one or more processors, that the newly minted NFT is associated with the individual; and/or in response to determining that the newly minted NFT corresponds to the individual, prompting, via the one or more processors, the individual to purchase insurance for an item associated with the NFT.

In some embodiments, the insured items are insured as part of a homeowners insurance policy.

In some embodiments, the insured items may include: electronic items, furniture, and/or kitchen appliances.

In some embodiments, the computer-implemented method further may include displaying, via the one or more processors, a virtual representation of the insured items of the NFTs of the digital wallet.

In some embodiments, displaying the virtual representation of the insured items of the NFTs further may include displaying insurance premiums, insurance coverage amounts, and/or insurance deductibles for the insured items of the NFTs of the digital wallet.

In some embodiments, the insured items may include one or more virtual insured items corresponding to a virtual environment, and the displaying the virtual representation may further include presenting the one or more virtual insured items in the virtual environment.

In some embodiments, the insured items may include: (i) one or more virtual insured items corresponding to a virtual environment, and (ii) one or more physical insured items, and wherein the displaying the virtual representation of the insured items further comprises: displaying, via the one or more processors, a list of the one or more physical insured items; and/or presenting, via the one or more processors, the one or more virtual insured items in the virtual environment.

In some embodiments, the insured items may include: (i) one or more virtual insured items corresponding to a virtual environment, and/or (ii) one or more physical insured items, and wherein the displaying the virtual representation of the insured items further may include: receiving, via the one or more processors and from the individual, a selection of viewing either the one or more virtual insured items, or the one or more physical insured items; and/or depending upon the selection, via the one or more processors, either: displaying, via the one or more processors, a list of the one or more physical insured items; or presenting, via the one or more processors, the one or more virtual insured items in the virtual environment.

In another aspect, a computer system configured to update an inventory of insured items may be provided. The computer system may include one or more processors configured to: (1) identify a digital wallet of non-fungible tokens (NFTs) configured to store NFTs that correspond to insured items associated with an individual; (2) detect a request to add a NFT corresponding to an insured item to the digital wallet; and/or (3) update the digital wallet to include the NFT, wherein the update to the digital wallet triggers a smart contract associated with the digital wallet to update an insurance policy based upon the updated digital wallet. The computer system may include additional, less, or alternate functionality, including that discussed elsewhere herein.

In yet another aspect, a computer device configured to update an inventory of insured items may be provided. The computer device may include: one or more processors; and/or one or more memories coupled to the one or more processors. The one or more memories including computer executable instructions stored therein that, when executed by the one or more processors, may cause the one or more processors to: (1) identify a digital wallet of non-fungible tokens (NFTs) configured to store NFTs that correspond to insured items associated with an individual; (2) detect a request to add a NFT corresponding to an insured item to the digital wallet; and/or (3) update the digital wallet to include the NFT, wherein the update to the digital wallet triggers a smart contract associated with the digital wallet to update an insurance policy based upon the updated digital wallet. The computer device may include additional, less, or alternate functionality, including that discussed elsewhere herein.

In some embodiments, the one or more memories including computer executable instructions stored therein that, when executed by the one or more processors, further may cause the one or more processors to display a virtual representation of the insured items of the NFTs.

In some embodiments, the insured items may include one or more physical insured items.

### Other Matters

Although the text herein sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (code embodied on a non-transitory, tangible machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC) to perform certain operations). A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

Upon reading this disclosure, those of skill in the art will appreciate still additional alternative structural and functional designs for the approaches described herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The particular features, structures, or characteristics of any specific embodiment may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

While the preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein.

It is therefore intended that the foregoing detailed description be regarded as illustrative rather than limiting, and that it be understood that it is the following claims, including all equivalents, that are intended to define the spirit and scope of this invention.

Furthermore, the patent claims at the end of this patent application are not intended to be construed under 35 U.S.C. § 112(f) unless traditional means-plus-function language is expressly recited, such as “means for” or “step for” language being explicitly recited in the claim(s). The systems and methods described herein are directed to an improvement to computer functionality, and improve the functioning of conventional computers.

What is claimed:

1. A computer-implemented method for updating an inventory of insured items, comprising:
identifying, via one or more processors, a digital wallet of non-fungible tokens (NFTs) configured to store NFTs that correspond to insured items associated with an individual;
detecting, via the one or more processors, a request to add a NFT corresponding to an insured item to the digital wallet; and
updating, via the one or more processors, the digital wallet to include the NFT, wherein the update to the digital wallet triggers a smart contract associated with the digital wallet to update an insurance policy based upon the updated digital wallet.

2. The computer-implemented method of claim 1, wherein the update to the insurance policy comprises an update to a list of insured items covered by the insurance policy based upon the updated digital wallet.

3. The computer-implemented method of claim 2, further comprising:
generating, via the one or more processors, the smart contract, wherein the smart contract is configured to: (i) determine, based upon a type of the insured item, an insurance policy that the insured item corresponds to, and (ii) add the insured item to the list of insured items of the insurance policy.

4. The computer-implemented method of claim 1, wherein the update to the insurance policy comprises an update to an insurance premium of the insurance policy based upon the updated digital wallet.

5. The computer-implemented method of claim 1, further comprising:
generating, via the one or more processors, the smart contract, wherein the smart contract is configured to trigger upon detecting an indication that the digital wallet has been updated.

6. The computer-implemented method of claim 1, further comprising:
analyzing, via the one or more processors, a distributed ledger to determine NFTs corresponding to additional insured items associated with the individual;
presenting, via the one or more processors, representations of the additional insured items to the individual;
receiving, via the one or more processors and from a user device associated with the individual, a selection of one or more of the additional insured items associated with the individual to be added to the digital wallet; and
adding, via the one or more processors, the selected one or more additional insured items to the digital wallet.

7. The computer-implemented method of claim 1, further comprising:
receiving, via the one or more processors, smart home data from one or more smart home devices associated with the individual;
analyzing, via the one or more processors, the smart home data to identify items that correspond to an NFT associated with insurance coverage; and
adding the identified items to the digital wallet.

8. The computer-implemented method of claim 1, further comprising:
automatically receiving, via the one or more processors, an indication that an NFT has been newly minted;
determining, via the one or more processors, that the newly minted NFT corresponds to an insured item;
determining, via the one or more processors, that the insured item is associated with the individual; and
in response to the determinations that the newly minted NFT corresponds to the insured item, and that the insured item is associated with the individual, adding, via the one or more processors the item to the digital wallet.

9. The computer-implemented method of claim 1, further comprising:
automatically receiving, via the one or more processors, an indication that an NFT has been newly minted;
determining, via the one or more processors, that the newly minted NFT is associated with the individual; and
in response to determining that the newly minted NFT corresponds to the individual, prompting, via the one or more processors, the individual to purchase insurance for an item associated with the NFT.

10. The computer-implemented method of claim 1, wherein the insured items are insured as part of a homeowners insurance policy.

11. The computer-implemented method of claim 7, wherein the insured items comprise: electronic items, furniture, and/or kitchen appliances.

12. The computer-implemented method of claim 1, further comprising displaying, via the one or more processors, a virtual representation of the insured items of the NFTs of the digital wallet.

13. The computer-implemented method of claim 12, wherein displaying the virtual representation of the insured items of the NFTs further comprises displaying insurance premiums, insurance coverage amounts, and/or insurance deductibles for the insured items of the NFTs of the digital wallet.

14. The computer-implemented method of claim 12, wherein the insured items comprise one or more virtual insured items corresponding to a virtual environment, and wherein the displaying the virtual representation further comprises presenting the one or more virtual insured items in the virtual environment.

15. The computer-implemented method of claim 12, wherein the insured items comprise: (i) one or more virtual insured items corresponding to a virtual environment, and (ii) one or more physical insured items, and wherein the displaying the virtual representation of the insured items further comprises:
displaying, via the one or more processors, a list of the one or more physical insured items; and
presenting, via the one or more processors, the one or more virtual insured items in the virtual environment.

16. The computer-implemented method of claim 12, wherein the insured items comprise: (i) one or more virtual insured items corresponding to a virtual environment, and (ii) one or more physical insured items, and wherein the displaying the virtual representation of the insured items further comprises:
receiving, via the one or more processors and from the individual, a selection of viewing either the one or more virtual insured items, or the one or more physical insured items; and
depending upon the selection, via the one or more processors, either:
displaying, via the one or more processors, a list of the one or more physical insured items; or
presenting, via the one or more processors, the one or more virtual insured items in the virtual environment.

17. A computer system configured to update an inventory of insured items, the computer system comprising one or more processors configured to:
identify a digital wallet of non-fungible tokens (NFTs) configured to store NFTs that correspond to insured items associated with an individual;
detect a request to add a NFT corresponding to an insured item to the digital wallet; and
update the digital wallet to include the NFT, wherein the update to the digital wallet triggers a smart contract associated with the digital wallet to update an insurance policy based upon the updated digital wallet.

18. A computer device configured to update an inventory of insured items, the computer device comprising:
one or more processors; and
one or more memories coupled to the one or more processors;
the one or more memories including computer executable instructions stored therein that, when executed by the one or more processors, cause the one or more processors to:
identify a digital wallet of non-fungible tokens (NFTs) configured to store NFTs that correspond to insured items associated with an individual;
detect a request to add a NFT corresponding to an insured item to the digital wallet; and
update the digital wallet to include the NFT, wherein the update to the digital wallet triggers a smart contract associated with the digital wallet to update an insurance policy based upon the updated digital wallet.

19. The computer device of claim 18, wherein the one or more memories including computer executable instructions stored therein that, when executed by the one or more processors, further cause the one or more processors to display a virtual representation of the insured items of the NFTs.

20. The computer device of claim 18, wherein the insured items comprise one or more physical insured items.
